(19) United States
(12) Patent Application Publication
(10) Pub. No.: US 2026/0003118 A1
(43) Pub. Date: Jan. 1, 2026

(54) OPTICAL FIBERS WITH LOW BEND LOSS

(71) Applicant: CORNING INCORPORATED, Corning, NY (US)

(72) Inventors: Snigdharaj Kumar Mishra, Wilmington, NC (US); Pushkar Tandon, Painted Post, NY (US)

(21) Appl. No.: 19/225,160

(22) Filed: Jun. 2, 2025

Related U.S. Application Data
(60) Provisional application No. 63/665,666, filed on Jun. 28, 2024.

(51) Int. Cl. G02B 6/02; G02B 6/028; G02B 6/036

(52) U.S. Cl. CPC G02B 6/02071; G02B 6/02104; G02B 6/0281; G02B 6/03638

(57) ABSTRACT

An optical fiber may include a core region and a cladding region surrounding the core region. The cladding region may include an inner cladding region surrounding the core region, a depressed-index cladding region surrounding the inner cladding region, and an outer cladding region surrounding the depressed-index cladding region. The inner cladding region may include a thickness greater than or equal to 1 μm. The depressed-index cladding region may include a first region and a second region, wherein a relative refractive index of the depressed-index cladding region may decrease monotonically with increasing radius in the first region, and wherein the relative refractive index of the depressed-index cladding region may be substantially constant in the second region. The optical fiber may achieve low microbend loss with large mode field diameter, while also maintaining low macrobend loss, low cable cutoff, and/or a zero dispersion wavelength between 1300 nm and 1324 nm.

This application claims the benefit of priority under 35 U.S.C. § 119 of U.S. Application Ser. No. 63/665,666 filed on Jun. 28, 2024, the content of which is relied upon and incorporated herein by reference in its entirety.

### FIELD

The present disclosure relates to optical fibers with low bend loss, and in particular, to single-mode optical fibers with low microbend loss, as well as low macrobend loss.

### BACKGROUND

Low loss optical fibers having a mode field diameter (MFD) greater than or equal to 9 μm at 1310 nm and having good bend performance are attractive as these fibers are mode field matched to standard single mode fibers and have low macrobend losses from the bends the fibers encounter inside a cable. Some existing fibers have bend performance that is compliant with G.657.A1 specifications. The latest trend in the industry is to have further reduced macrobend loss (A2 compliant) and microbend loss. Optical fibers having MFD at 1310 nm of greater than or equal to 9 μm and compliant with ITU-G.657.A2 specifications are becoming increasingly important for high fiber density cables used in data center interconnects and smaller diameter cables in congested duct applications. For high density cables, the microbend loss of the fibers plays an important role for acceptable cable performance. It can be particularly challenging for high density cables to achieve acceptable cable performance at low temperature, e.g., −40° C., which is dominated by the microbend loss of the fiber. Therefore, there is a need for optical fibers that have MFD greater than or equal to 9 μm at 1310 μm and have not only low macrobend loss but also reduced microbend loss.

### SUMMARY

Described herein are low loss optical fibers having MFD greater than or equal to 9 μm at 1310 nm and having reduced macrobend and microbend losses and ITU-G.657.A2 compliant. The low loss optical fibers described herein may demonstrate superior bend performance that may be used for high fiber density cables in data center interconnects and smaller diameter cables in congested duct applications.

In some embodiments, an optical fiber may include a core region and a cladding region surrounding the core region. The cladding region may include an inner cladding region surrounding the core region, a depressed-index cladding region surrounding the inner cladding region, and an outer cladding region surrounding the depressed-index cladding region. In some embodiments, the inner cladding region may include a thickness greater than or equal to 1 μm. In some embodiments, the depressed-index cladding region may include a first region and a second region, wherein a relative refractive index of the depressed-index cladding region may decrease monotonically with increasing radius in the first region, and wherein the relative refractive index of the depressed-index cladding region may be substantially constant in the second region. In some embodiments, a minimum relative refractive index Δ_{3 min} of the depressed-index cladding region may be less than or equal to −0.4%. In some embodiments, a trench volume of the depressed-index cladding region may be greater than or equal to 30%-micron² and less than or equal to 70%-micron². In some embodiments, the optical fiber may exhibit at least one of: a MACC value, at 1310 nm wavelength, greater than or equal to 7.5 and less than or equal to 8.2, a mode field diameter at 1310 μm wavelength greater than or equal to 9.0 μm, a cable cutoff less than or equal to 1260 nm, a zero dispersion wavelength greater than or equal to 1300 nm and less than or equal to 1324 nm. In some embodiments, the optical fiber may further exhibit at least one of: a macrobend loss, as determined by 1×15 mm diameter mandrel wrap test at 1310 nm wavelength, less than or equal to 0.02 dB/turn; a macrobend loss, as determined by 1×20 mm diameter mandrel wrap test at 1310 nm wavelength, less than or equal to 0.002 dB/turn; or a macrobend loss, as determined by 1×30 mm diameter mandrel wrap test at 1310 nm wavelength, less than or equal to 0.00005 dB/turn.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a schematic view of a cross-section of an exemplary coated optical fiber.

FIG. 2 is a schematic view of a cross-section of an exemplary glass fiber.

FIG. 3 depicts an exemplary relative refractive index profile of a glass fiber.

FIG. 4 depicts additional exemplary relative refractive index profiles of glass fibers.

FIG. 5 plots model prediction of microbend loss as a function of wavelength for the exemplary fibers shown in FIG. 4.

FIG. 6 plots model prediction of microbend loss at 1625 nm for the exemplary fibers shown in FIG. 4.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

In this specification and in the claims which follow, reference will be made to a number of terms which shall be defined to have the following meanings:

“Optical fiber” refers to a waveguide having a glass portion surrounded by a coating. The glass portion includes a core and a cladding and is referred to herein as a “glass fiber”.

“Radial position”, “radius”, or the radial coordinate “r” refers to radial position relative to the centerline (r=0) of the fiber.

“Refractive index” refers to the refractive index at a wavelength of 1550 nm, unless otherwise specified.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (e.g., core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g., core region and/or any of the cladding regions) is expressed as a single value or as a parameter (e.g., Δ or Δ %) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined by equation (1) below, unless otherwise specified. Whether by design or a consequence of normal manufacturing variability, the dependence of relative refractive index on radial position may be sloped, curved, or otherwise non-constant.

“Relative refractive index,” as used herein, is defined in equation (1) as:

$${Δ}_{i} ( {r}_{i} ) \% = 100 \frac{( {n}_{i}^{2} - {n}_{ref}^{2} )}{2 {n}_{i}^{2}} \qquad ( 1 )$$

where nᵢ is the refractive index at radial position rᵢ in the glass fiber, unless otherwise specified, and n_{ref} is the refractive index of pure silica glass, unless otherwise specified. Accordingly, as used herein, the relative refractive index percent is relative to pure silica glass, which has a value of 1.444 at a wavelength of 1550 nm. As used herein, the relative refractive index is represented by Δ (or “delta”) or Δ % (or “delta %) and its values are given in units of “%”, unless otherwise specified. Relative refractive index may also be expressed as Δ(r) or Δ(r)%.

The average relative refractive index (□ₐᵥₑ) of a region of the fiber is determined from equation (2):

$${Δ}_{ave} = {\int }_{{r}_{inner}}^{{r}_{outer}} \frac{Δ ( r ) d r}{( {r}_{outer} - {r}_{inner} )} \qquad ( 2 )$$

where rᵢₙₙₑᵣ is the inner radius of the region, rₒᵤₜₑᵣ is the outer radius of the region, and Δ(r) is the relative refractive index of the region.

The refractive index of an optical fiber profile may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)−nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined by equation (1).

The term “α-profile” or “alpha profile” refers to a relative refractive index profile Δ(r) that has the functional form defined in equation (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, Δ(r₀)>0, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and a is a real number. Δ(r₀) for an α-profile may be referred to herein as Δₘₐₓ or, when referring to a specific region i of the fiber, as Δᵢₘₐₓ. When the relative refractive index profile of the fiber core region is described by an α-profile with r₀ occurring at the centerline (r=0), r_{z} corresponding to the outer radius r₁ of the core region, and Δ₁(r₁)=0, equation (3) simplifies to equation (4):

$${Δ}_{1} ( r ) = {Δ}_{1 m ax} [ 1 - {[ \frac{r}{{r}_{1}} ]}^{α} ] \qquad ( 4 )$$

When the core region has an index described by equation (4), the outer radius r₁ can be determined from the measured relative refractive index profile by the following procedure. Estimated values of the maximum relative refractive index Δ_{1 max}, α, and outer radius r₁ₑₛₜ are obtained from inspection of the measured relative refractive index profile and used to create a trial function Δₜᵣᵢₐₗ between r=0 and r=r₁ₑₛₜ. The sum of the squares of the difference between the trial function and the measured profile (Dₘₑₐₛ), l²=S(Dₜᵣᵢₐₗ−Dₘₑₐₛ)², is minimized over values of r ranging between 0.1 r₁ₑₛₜ and 0.95 r₁ₑₛₜ using the Nelder-Mead algorithm (Nelder, John A. and R. Mead, “A simplex method for function minimization,” Computer Journal 7: 308-313 (1965)) to determine D_{1 max}, a, and r₁.

The “core volume” V₁ is defined as:

$${V}_{1} = 2 {\int }_{0}^{{r}_{1}} {Δ}_{1} ( r ) rdr \qquad ( 5 )$$

where r₁ is the outer radius of the refractive index profile of the core region, Δ₁(r) is the relative refractive index of the core region of the refractive index profile, and r is radial position in the fiber. The core volume V₁ is a positive quantity and will be expressed herein in units of % Δ-μm², which may also be expressed as % Δμm² or % Δ-micron², or % Δ-sq. microns, or %-micron².

“Trench volume” is defined as:

$${V}_{Trench} = 2 {\int }_{{r}_{T r e nch , inner}}^{{r}_{T r e nch , outer}} {Δ}_{Trench} ( r ) r d r \qquad ( 6 )$$

where r_{Trench,inner} is the inner radius of the trench region of the refractive index profile, r_{Trench,outer} is the outer radius of the trench region of the refractive index profile, Δ_{Trench}(r) is the relative refractive index of the trench region of the refractive index profile, and r is radial position in the fiber. Trench volume will be expressed herein in units of % Δmicron², % Δ-micron², % Δ-μm², % Δμm², or %-micron², whereby these units can be used interchangeably herein. A trench region may also referred to as a depressed-index cladding region. In some instances, the trench volume may be a negative quantity as the relative refractive index Δ_{Trench}(r) of the trench region may be negative. Thus, in some instances, the trench volume may be discussed using its absolute value |V_{Trench}|.

The “mode field diameter” or “MFD” of an optical fiber is defined in equation (7) as:

$$MFD = 2 w \qquad ( 7 )$$

$${w}^{2} = 2 \frac{{\int }_{0}^{∞} {( f ( r ) )}^{2} rdr}{{\int }_{0}^{∞} {( \frac{df ( r )}{dr} )}^{2} rdr}$$

where f(r) is the transverse component of the electric field distribution of the guided optical signal and r is radial position in the fiber. “Mode field diameter” or “MFD” depends on the wavelength of the optical signal and may be reported for wavelengths of 1310 nm, 1550 nm, and 1625 nm. Specific indication of the wavelength will be made when referring to mode field diameter herein. Unless otherwise specified, mode field diameter refers to the LP₀₁ mode at the specified wavelength.

“Effective area” of an optical fiber is defined in equation (8) as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 8 )$$

where f(r) is the transverse component of the electric field of the guided optical signal and r is radial position in the fiber. “Effective area” or “A_{eff}” depends on the wavelength of the optical signal and may be reported for wavelengths of 1310 nm, 1550 nm, etc. Specific indication of the wavelength will be made when referring to effective area.

The term “attenuation,” as used herein, is the loss of optical power as the signal travels along the optical fiber. Attenuation was measured as specified by the IEC-60793-1-40 standard, “Attenuation measurement methods.”

The bend resistance of an optical fiber, expressed as “bend loss” or more specifically, “macrobend loss” herein, can be gauged by induced attenuation under prescribed test conditions as specified by the IEC-60793-1-47 standard, “Measurement methods and test procedures—Macrobending loss.” For example, the test condition can entail deploying or wrapping the fiber one or more turns around a mandrel of a prescribed diameter, e.g., by wrapping 1 turn around either a 15 mm, 20 mm, or 30 mm or similar diameter mandrel (e.g., “1×15 mm diameter bend loss” or the “1×20 mm diameter bend loss” or the “1×30 mm diameter bend loss”) and measuring the increase in attenuation per turn.

Microbend loss of the experimental examples was determined by the test described as Method A in Section 5.1 of the International Electrotechnical Commission Technical Report IEC TR62221 Measurement Methods—Microbending Sensitivity using sandpaper (grade 40 microns, mineral Al₂O₃) as the fixed roughness material (see Section 4.5). In the test, a length of 600 m to 700 m of the optical fiber was wound at a fixed winding tension about a drum having a radius of 153 mm that was covered with the sandpaper. The microbend loss can be determined for winding tensions of 30.0 g, 60.0 g, and 90.0 g, which correspond to winding forces of 0.196 g/mm, 0.392 g/mm, and 0.588 g/mm, respectively.

“Cable cutoff wavelength,” or “cable cutoff,” as used herein, refers to the cable cutoff test specified by the IEC 60796-1-44 standard and is defined as the wavelength at which the second-order modes undergo 19.3 dB more attenuation than the LP01 mode, which is measured on a fiber sample having a length of 22 m with 80 mm diameter loops at both ends.

“Fiber cutoff” can be measured by the standard 2 m fiber cutoff test, FOTP-80 (EIA-TIA-455-80), to yield the “fiber cutoff wavelength”, also known as the “2 m fiber cutoff” or “measured cutoff”. The FOTP-80 standard test is performed to either strip out the higher order modes using a controlled amount of bending, or to normalize the spectral response of the fiber to that of a multimode fiber.

“Theoretical fiber cutoff wavelength,” or “theoretical fiber cutoff”, or “theoretical cutoff”, for a given mode, is the wavelength above which guided light cannot propagate in that mode. A mathematical definition can be found in Single Mode Fiber Optics, Jeunhomme, pp. 39-44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

### Fiber Configuration

The optical fibers disclosed herein include a core region, a cladding region surrounding the core region, and a coating surrounding the cladding region. The core region and cladding region are glass. The cladding region may include multiple regions. The multiple cladding regions may be concentric regions. The cladding region may include an inner cladding region, a depressed-index cladding region, and an outer cladding region. The inner cladding region may surround and may be directly adjacent to the core region. The depressed-index cladding region may surround and may be directly adjacent to the inner cladding region such that the depressed-index cladding region may be disposed between the inner cladding region and the outer cladding region in a radial direction. The outer cladding region may surround and may be directly adjacent to the depressed-index cladding region.

The depressed-index cladding region may have a lower relative refractive index than each of the inner cladding region and the outer cladding region. The relative refractive index of the inner cladding region may be less than, equal to, or greater than the relative refractive index of the outer cladding region. The depressed-index cladding region may be referred to herein as a trench or trench region.

Whenever used herein, relative refractive index Δ₁ or Δ₁(r) refer to the core region, relative refractive index Δ₂ or Δ₂(r) refer to the inner cladding region, relative refractive index Δ₃ or Δ₃(r) refer to the depressed-index cladding region, and relative refractive index Δ₄ or Δ₄(r) refer to the outer cladding region.

The relative refractive index Δ₁(r) has a maximum value Δ_{1 max} and a minimum value Almin. The relative refractive index Δ₂(r) has a maximum value Δ_{2 max} and a minimum value Δ_{2 min}. The relative refractive index Δ₃(r) has a maximum value Δ_{3 max} and a minimum value Δ_{3 min}. The relative refractive index Δ₄(r) has a maximum value Δ_{4 max} and a minimum value Δ_{4 min}. In embodiments in which the relative refractive index is constant or approximately constant over a region, the maximum and minimum values of the relative refractive index are equal or approximately equal. Unless otherwise specified, if a single value is reported for the relative refractive index of a region, the single value corresponds to an average value for the region.

It is understood that the central core region may be substantially cylindrical in shape and that the surrounding inner cladding region, depressed-index cladding region, outer cladding region, primary coating, and secondary coating may be substantially annular in shape. Annular regions are characterized in terms of an inner radius and an outer radius. Radial positions r₁, r₂, r₃, r₄, r₅, r₆, r₇ refer herein to the outermost radii of the core region, inner cladding region, depressed-index cladding region, outer cladding region, primary coating, secondary coating, and tertiary coating, respectively. The radius r₆ also corresponds to the outer radius of the optical fiber in embodiments without a tertiary coating. When a tertiary coating is present, the radius r₇ corresponds to the outer radius of the optical fiber.

The difference or radial distance between radial position r₂ and radial position r₁ is the thickness of the inner cladding region. The difference or radial distance between radial position r₃ and radial position r₂ is the thickness of the depressed-index cladding region. The difference or radial distance between radial position r₄ and radial position r₃ is the thickness of the outer cladding region. The difference or radial distance between radial position r₅ and radial position r₄ is the thickness of the primary coating. The difference or radial distance between radial position r₆ and radial position r₅ is the thickness of the secondary coating.

Reference will now be made in detail to illustrative embodiments of the present description.

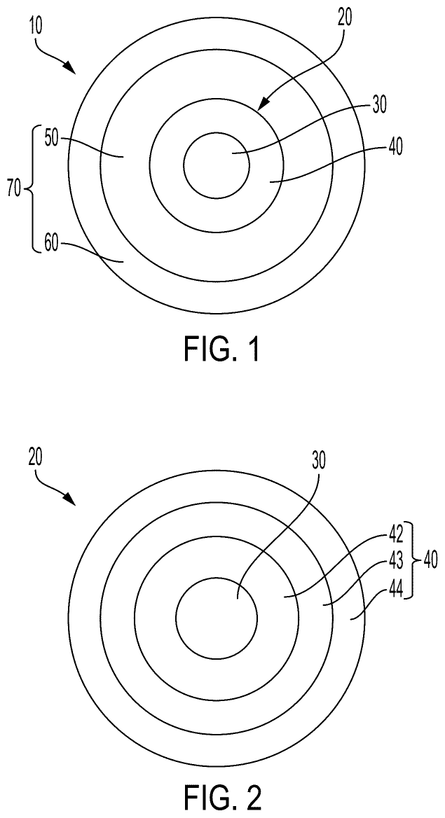

One embodiment relates to an optical fiber. The optical fiber includes a glass fiber surrounded by a coating. An exemplary optical fiber 10 is shown in schematic cross-sectional view in FIG. 1. The optical fiber 10 may include a glass fiber 20 and a coating 70 surrounding and directly contacting the glass fiber 20. The glass fiber 20 may include a core region 30 and a cladding region 40 surrounding and directly contacting the core region 30. The coating 70 may include a primary coating 50, a secondary coating 60, and/or one or more tertiary layers may surround the secondary coating 60. Further description of the glass fiber 20 and the coating 70 is provided below.

A schematic cross-sectional depiction of the glass fiber 20 is shown in FIG. 2. As shown in FIG. 2, the cladding region 40 surrounds the core region 30. The core region 30 may have a higher refractive index than the cladding region 40, and the glass fiber 20 functions as a waveguide. In some embodiments, the core region 30 and the cladding region 40 may have a discernible core-cladding boundary. Alternatively, the core region 30 and the cladding region 40 may lack a distinct boundary. The cladding region 40 may include an inner cladding region 42, a depressed-index cladding region or trench region 43, and an outer cladding region 44.

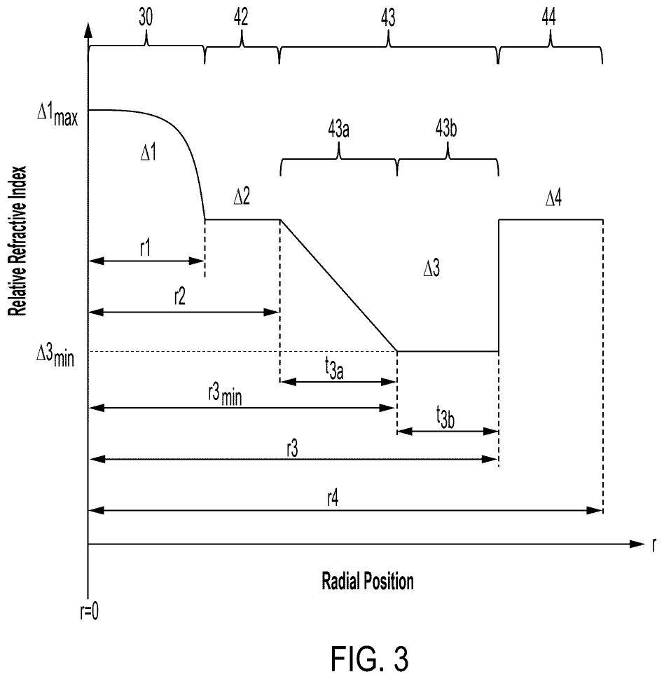

FIG. 3 plots an idealized relative refractive index profile of the glass fiber 20 as the relative refractive index A versus the radial position r. The core region 30 has relative refractive index 41, with a maximum refractive index of Δ_{1 max} at r=0 and a gradient α-profile, which is described in greater detail below. The inner cladding region 42 has a relative refractive index Δ₂. The depressed-index cladding region 43 has a relative refractive index Δ₃, with a minimum refractive index Δ_{3 min}. The outer cladding region 44 has a relative refractive index Δ₄. In some embodiments, Δ₄=Δ₂. In some embodiments, Δ_{3 min}<Δ₂ and Δ_{3 min}<Δ₄. In some embodiments, Δ₁>Δ₂>Δ₃ and Δ₄>Δ₃. Other configurations for the relative refractive index profile are discussed further below.

### Core Region

The core region 30 may include silica glass that may be either un-doped silica glass, up-doped silica glass, and/or down-doped silica glass. Up-doped silica glass may include silica glass doped with, for example, germanium (e.g., GeO₂), phosphorus (e.g., P₂O₅), aluminum (e.g., Al₂O₃), chlorine, or an alkali metal oxide (e.g., Na₂O, K₂O, Li₂O, Cs₂O, or Rb₂O). In some embodiments, the core may include germanium doped glass having a germanium concentration between about 4 wt. % and about 8 wt. %. In embodiments where the core may be doped with an alkali dopant, the peak concentration of the alkali in the silica glass may range from about 10 ppm to about 500 ppm, or from about 30 ppm to about 400 ppm. In yet other embodiments, the silica glass of the core region 30 may be free of germanium and/or chlorine; that is the core region may include silica glass that lacks germanium and/or chlorine. Down-doped silica glass may include silica glass doped with, for example, fluorine or boron.

As discussed above, the relative refractive index of the core region 30 of the glass fiber 20 can be described by an α-profile. In some embodiments, the α value may be greater than or equal to (i.e., ≥) 2 and less than or equal to (i.e., ≤) 20—including all sub-ranges or values therebetween. For example, in some embodiments, the α value may be ≥2 and ≤20, ≥2 and ≤18, ≥2 and ≤16, ≥2 and ≤14, ≥2 and ≤12, ≥2 and ≤10, ≥2 and ≤8, ≥2 and ≤6, ≥6 and ≤20, ≥6 and ≤18, ≥6 and ≤16, ≥6 and ≤14, ≥6 and ≤12, ≥6 and ≤10, ≥6 and ≤8, ≥8 and ≤20, ≥8 and ≤18, ≥8 and ≤16, ≥8 and ≤14, ≥8 and ≤12, ≥8 and ≤10, ≥10 and ≤20, ≥10 and ≤18, ≥10 and ≤16, ≥10 and ≤14, ≥10 and ≤12, ≥12 and ≤20, ≥12 and ≤18, ≥12 and ≤16, ≥12 and ≤14, ≥14 and ≤20, ≥14 and ≤18, ≥14 and ≤16, ≥16 and ≤20, ≥16 and ≤18, or ≥18 and ≤20.

In some embodiments, the α value may be less than or equal to (i.e., ≤) 20, ≤19, ≤18, ≤17, ≤16, ≤15, ≤14, ≤13, ≤12, ≤11, ≤10, ≤9, ≤8, ≤7, ≤6, ≤5, ≤4, ≤3, or less. In some embodiments, the α value may be greater than or equal to (i.e., ≥) 2, ≥3, ≥4, ≥5, ≥6, ≥7, ≥8, ≥9, ≥10, ≥11, ≥12, ≥13, ≥14, ≥15, ≥16, ≥17, ≥18, ≥19, or greater.

The outer radius r₁ of the core region 30 may be greater than or equal to (i.e., ≥) 3 μm and less than or equal to (i.e., ≤) 7 μm—including all sub-ranges or values therebetween. For example, in some embodiments, the outer radius r₁ of the core region 30 may be ≥3 μm and ≤7 μm, ≥3 μm and ≤6 μm, ≥3 μm and ≤5 μm, ≥3 μm and ≤4 μm, ≥4 μm and ≤7 μm, ≥4 μm and ≤6 μm, ≥4 μm and ≤5 μm, ≥5 μm and ≤7 μm, ≥5 μm and ≤6 μm, or ≥6 μm and ≤7 μm. In some embodiments, the outer radius r₁ of the core region 30 may be greater than or equal to (i.e., ≥) 3 μm, ≥3.5 μm, ≥4 μm, ≥4.5 μm, ≥5 μm, ≥5.5 μm, ≥6 μm, ≥6.5 μm, or greater. In some embodiments, the radius r₁ of the core region 30 may be less than or equal to (i.e., ≤) 7 μm, ≤6.5 μm, ≤6 μm, ≤5.5 μm, ≤5 μm, ≤4.5 μm, ≤4 μm, ≤3.5 μm, or less.

The maximum relative refractive index Δ_{1 max} of the core region 30 may be greater than or equal to (i.e., ≥) 0.3% and less than or equal to (i.e., ≤) 0.5%—including all sub-ranges or values therebetween. For example, in some embodiments, the maximum relative refractive index Δ_{1 max} of the core region 30 may be ≥0.3% and ≤0.5%, ≥0.3% and ≤0.45%, ≥0.3% and ≤0.4%, ≥0.3% and ≤0.35%, ≥0.35% and ≤0.5%, ≥0.35% and ≤0.45%, ≥0.35% and ≤0.4%, ≥0.4% and ≤0.5%, ≥0.4% and ≤0.45%, or ≥0.45% and ≤0.5%.

In some embodiments, the maximum relative refractive index Δ_{1 max} of the core region 30 may be greater than or equal to (i.e., ≥) 0.3%, ≥0.32% ≥0.34%, ≥0.36%, ≥0.38%, ≥0.4%, ≥0.42%, ≥0.44%, ≥0.46%, ≥0.48%, or greater. In some embodiments, the maximum relative refractive index Δ₀ or Δ_{1 max} of the core region 30 may be less than or equal to (i.e., ≤) 0.5%, ≤0.49%, ≤0.47%, ≤0.45%, ≤0.43%, ≤0.41%, ≤0.4%, ≤0.39%, ≤0.37%, ≤0.35%, ≤0.33%, ≤0.31%, or less.

Although not depicted in FIG. 3, in some embodiments, the relative refractive index of the core region 30 may have a centerline dip such that the maximum refractive index of the core region 30 and the maximum refractive index of the entire optical fiber 10 may be located a small distance away from the centerline of the core region 30 rather than at the centerline of the core region 30, as depicted in FIG. 3.

In some embodiments, the core region 30 may have a core volume Vi that may be greater than or equal to (i.e., ≥) 2%-micron² and less than or equal to (i.e., ≤) 0%-micron^{2—}including all sub-ranges or values therebetween. For example, in some embodiments, the core volume V₁ may be ≥2%-micron² and ≤10%-micron², ≥2%-micron² and ≤9%-micron², ≥2%-micron² and ≤8%-micron², ≥2%-micron² and ≤7%-micron², ≥2%-micron² and ≤6%-micron², ≥2%-micron² and ≤5%-micron², ≥2%-micron² and ≤4%-micron², ≥2%-micron² and ≤3%-micron², ≥3%-micron² and ≤10%-micron², ≥3%-micron² and ≤9%-micron², ≥3%-micron² and ≤8%-micron², ≥3%-micron² and ≤7%-micron², ≥3%-micron² and ≤6%-micron², ≥3%-micron² and ≤5%-micron², ≥3%-micron² and ≤4%-micron², ≥4%-micron² and ≤10%-micron², ≥4%-micron² and ≤9%-micron², ≥4%-micron² and ≤8%-micron², ≥4%-micron² and ≤7%-micron², ≥4%-micron² and ≤6%-micron², ≥4%-micron² and ≤5%-micron², ≥5%-micron² and ≤10%-micron², ≥5%-micron² and ≤9%-micron², ≥5%-micron² and ≤8%-micron², ≥5%-micron² and ≤7%-micron², ≥5%-micron² and ≤6%-micron², ≥6%-micron² and ≤10%-micron², ≥6%-micron² and ≤9%-micron², ≥6%-micron² and ≤8%-micron², ≥6%-micron² and ≤7%-micron², ≥7%-micron² and ≤10%-micron², ≥7%-micron² and ≤9%-micron², ≥7%-micron² and ≤8%-micron², ≥8%-micron² and ≤10%-micron², ≥8%-micron² and ≤9%-micron^{2,} or ≥9%-micron² and ≤10%-micron².

In some embodiments, the core volume V₁ may be greater than or equal to (i.e., ≥) 2%-micron², ≥3%-micron², ≥4%-micron², ≥5%-micron², ≥6%-micron², ≥7%-micron²≥8%-micron², ≥9%-micron^{2,} or greater. In some embodiments, the core volume VI may be less than or equal to (i.e., ≤) 10%-micron², ≤9%-micron², ≤8%-micron², ≤7%-micron², ≤6%-micron², ≤5%-micron², ≤4%-micron², ≤3%-micron^{2,} or less.

### Inner Cladding Region

The inner cladding region 42 may include un-doped silica glass. The inner radius r₁ of the inner cladding region 42 may correspond to the outer radius r₁ of the core region 30, as discussed above. The outer radius r₂ of the inner cladding region 42 may be greater than or equal to (i.e., ≥) 6 μm and less than or equal to (i.e., ≤) 14 μm—including all sub-ranges or values therebetween. For example, in some embodiments, the outer radius r₂ of the inner cladding region 42 may be ≥6 μm and ≤14 μm, ≥6 μm and ≤13 μm, ≥6 μm and ≤12 μm, ≥6 μm and ≤11 μm, ≥6 μm and ≤10 μm, ≥6 μm and ≤9 μm, ≥6 μm and ≤8 μm, ≥6 μm and ≤7 μm, ≥7 μm and ≤14 μm, ≥7 μm and ≤13 μm, ≥7 μm and ≤12 μm, ≥7 μm and ≤11 μm, ≥7 μm and ≤10 μm, ≥7 μm and ≤9 μm, ≥7 μm and ≤8 μm, ≥8 μm and ≤14 μm, ≥8 μm and ≤13 μm, ≥8 μm and ≤12 μm, ≥8 μm and ≤11 μm, ≥8 μm and ≤10 μm, ≥8 μm and ≤9 μm, ≥9 μm and ≤14 μm, ≥9 μm and ≤13 μm, ≥9 μm and ≤12 μm, ≥9 μm and ≤11 μm, ≥9 μm and ≤10 μm, ≥10 μm and ≤14 μm, ≥10 μm and ≤13 μm, ≥10 μm and ≤12 μm, ≥10 μm and ≤11 μm, ≥11 μm and ≤14 μm, ≥11 μm and ≤13 μm, ≥11 μm and ≤12 μm, ≥12 μm and ≤14 μm, ≥12 and ≤13 μm, or ≥13 and ≤14 μm.

In some embodiments, the outer radius r₂ of the inner cladding region 42 may be greater than or equal to (i.e., ≥) 6 μm, ≥6.5 μm, ≥7 μm, ≥7.5 μm, ≥8 μm, ≥8.5 μm, ≥9 μm, ≥9.5 μm, ≥10 μm, ≥10.5 μm, ≥11 μm, ≥11.5 μm, ≥12 μm, ≥12.5 μm, ≥13 μm, ≥13.5 μm, or greater. In some embodiments, the outer radius r₂ of the inner cladding region 42 may be less than or equal to (i.e., ≤) 14 μm, ≤13.5 μm, ≤13 μm, ≤12.5 μm, ≤12 μm, ≤11.5 μm, ≤11 μm, ≤10.5 μm, ≤10 μm, ≤9.5 μm, ≤9 μm, ≤8.5 μm, ≤8 μm, ≤7.5 μm, ≤7 μm, ≤6.5 μm, or less.

The thickness of the inner cladding region 42 as defined by the difference between the radial position r₂ and the radial position r₁, i.e., r₂−r₁, may be greater than or equal to (i.e., ≥) 1 μm and less than or equal to (i.e., ≤) 10 μm—including all sub-ranges or values therebetween. For example, in some embodiments, the thickness of the inner cladding region 42, r₂−r₁, may be ≥1 μm and ≤10 μm, ≥1 μm and ≤8 μm, ≥1 μm and ≤6 μm, ≥1 μm and ≤4 μm, ≥1 μm and ≤2 μm, ≥3 μm and ≤10 μm, ≥3 μm and ≤8 μm, ≥3 μm and ≤6 μm, ≥3 μm and ≤4 μm, ≥5 μm and ≤10 μm, ≥5 μm and ≤8 μm, ≥5 μm and ≤6 μm, ≥7 μm and ≤10 μm, ≥7 μm and ≤8 μm, or ≥9 μm and ≤10 μm.

In some embodiments, the thickness of the inner cladding region 42, r₂−r₁, may be greater than or equal to (i.e., ≥) 1 μm, ≥2 μm, ≥3 μm, ≥4 μm, ≥5 μm, ≥6 μm, ≥7 μm, ≥8 μm, ≥9 μm, or greater. In some embodiments, the thickness of the inner cladding region 42, r₂−r₁, may be less than or equal to (i.e., ≤) 10 μm, ≤9 μm, ≤8 μm, ≤7 μm, ≤6 μm, ≤5 μm, ≤4 μm, ≤3 μm, ≤2 μm, or less.

The relative refractive index Δ₂ of the inner cladding region 42 may be greater than or equal to (i.e., ≥) −0.10% and less than or equal to (i.e., ≤) 0.10%—including all sub-ranges or values therebetween. For example, in some embodiments, the relative refractive index Δ₂ of the inner cladding region 42 may be ≥−0.10% and ≤0.10%, or ≥−0.05% and ≤0.05%. In some embodiments, the relative refractive index Δ₂ of the inner cladding region 42 may be greater than or equal to (i.e., ≥) −0.10%, ≥−0.05%, or greater. In some embodiments, the relative refractive index Δ₂ of the inner cladding region 42 may be less than or equal to (i.e., ≤) 0.10%, ≤0.05%, or less. In some embodiments, the relative refractive index Δ₂ may be about 0.0%. The relative refractive index Δ₂ may be preferably constant or approximately constant.

### Depressed-Index Cladding Region

The depressed-index cladding region 43 may include down-doped silica glass. In some embodiments, the depressed-index cladding region 43 may be down-doped with fluorine or boron. However, the down-doping of the depressed-index cladding region 43 may also be accomplished by incorporating voids in silica glass.

In some embodiments, the depressed-index cladding region 43 may include a trench design. In some embodiments, the depressed-index cladding region 43 may include an offset trench design in which the depressed-index cladding region 43 may be offset from the core region 30 by the inner cladding region 42. Thus, in some embodiments, the offset distance between the depressed-index cladding region 43 and the core region 30, more specifically, the offset distance between the inner radius r₂ of the depressed-index cladding region 43 and the outer radius r₁ of the core region 30, may correspond to the thickness of the inner cladding region 42 and may be greater than or equal to (i.e., ≥) 1 μm and less than or equal to (i.e., ≤) 10 μm—including all sub-ranges or values therebetween. For example, in some embodiments, the offset distance between the depressed-index cladding region 43 and the core region 30 may be ≥1 μm and ≤10 μm, ≥1 μm and ≤8 μm, ≥1 μm and ≤6 μm, ≥1 μm and ≤4 μm, ≥1 μm and ≤2 μm, ≥3 μm and ≤10 μm, ≥3 μm and ≤8 μm, ≥3 μm and ≤6 μm, ≥3 μm and ≤4 μm, ≥5 μm and ≤10 μm, ≥5 μm and ≤8 μm, ≥5 μm and ≤6 μm, ≥7 μm and ≤10 μm, ≥7 μm and ≤8 μm, or ≥9 μm and ≤10 μm.

In some embodiments, the offset distance between the depressed-index cladding region 43 and the core region 30 may be greater than or equal to (i.e., ≥) 1 μm, ≥2 μm, ≥3μm, ≥4 μm, ≥5 μm, ≥6 μm, ≥7 μm, ≥8 μm, ≥9 μm, or greater. In some embodiments, the offset distance between the depressed-index cladding region 43 and the core region 30 may be less than or equal to (i.e., ≤) 10 μm, ≤9 μm, ≤8 μm, ≤7 μm, ≤6 μm, ≤5 μm, ≤4 μm, ≤3 μm, ≤2 μm, or less.

As discussed above, the inner radius r₂ of the depressed-index cladding region 43 may correspond to the outer radius r₂ of the inner cladding region 42. The outer radius r₃ of the depressed-index cladding region 43 may be greater than or equal to (i.e., ≥) 8 μm and less than or equal to (i.e., ≤) 20 μm—including all sub-ranges or values therebetween. For example, in some embodiments, the outer radius r₃ of the depressed-index cladding region 43 may be ≥8 μm and ≤20 μm, ≥8 μm and ≤18 μm, ≥8 μm and ≤16 μm, ≥8 μm and ≤14 μm, ≥8 μm and ≤12 μm, ≥8 μm and ≤10 μm, ≥10 μm and ≤20 μm, ≥10 μm and ≤18 μm, ≥10 μm and ≤16 μm, ≥10 μm and ≤14 μm, ≥10 μm and ≤12 μm, ≥12 μm and ≤20 μm, ≥12 μm and ≤18 μm, ≥12 μm and ≤16 μm, ≥12 μm and ≤14 μm, ≥14 μm and ≤20 μm, ≥14 μm and ≤18 μm, ≥14 μm and ≤16 μm, ≥16 μm and ≤20 μm, ≥16 μm and ≤18 μm, or ≥18 μm and ≤20 μm.

In some embodiments, the outer radius r₃ of the depressed-index cladding region 43 may be greater than or equal to (i.e., ≥) 8 μm, ≥8.5 μm, ≥9 μm, ≥9.5 μm, ≥10 μm, ≥10.5 μm, ≥11 μm, ≥11.5 μm, ≥12 μm, ≥12.5 μm, ≥13 μm, ≥13.5 μm, ≥14 μm, ≥14.5 μm, ≥15 μm, ≥15.5 μm, ≥16 μm, ≥16.5 μm, ≥17 μm, ≥17.5 μm, ≥18 μm, ≥18.5 μm, ≥19 μm, ≥19.5 μm, or greater.

In some embodiments, the outer radius r₃ of the depressed-index cladding region 43 may be less than or equal to (i.e., ≤) 20 μm, ≤19.5 μm, ≤19 μm, ≤18.5 μm, ≤18 μm, ≤17.5 μm, ≤17 μm, ≤16.5 μm, ≤16 μm, ≤15.5 μm, ≤15 μm, ≤14.5 μm, ≤14 μm, ≤13.5 μm, ≤13 μm, ≤12.5 μm, ≤12 μm, ≤11.5 μm, ≤11 μm, ≤10.5 μm, ≤10 μm, ≤9.5 μm, ≤9 μm, ≤8.5 μm, or less .

In some embodiments, the thickness of the depressed-index cladding region 43 as defined by the difference between the radial position r₂ and the radial position r₃, i.e., r₃−r₂, may be greater than or equal to (i.e., ≥) 3 μm and less than or equal to (i.e., ≤) 15 μm—including all sub-ranges or values therebetween. For example, in some embodiments, the thickness of the depressed-index cladding region 43, r₃−r₂, may be ≥3 μm and ≤15 μm, ≥3 μm and ≤12 μm, ≥3 μm and ≤9 μm, ≥3 μm and ≤6 μm, ≥6 μm and ≤15 μm, ≥6 μm and ≤12 μm, ≥6 μm and ≤9 μm, ≥9 μm and ≤15 μm, ≥9 μm and ≤12 μm, or ≥12 μm and ≤15 μm.

In some embodiments, the thickness of the depressed-index cladding region 43, r₃−r₂, may be greater than or equal to (i.e., ≥) 3 μm, ≥4 μm, ≥5 μm, ≥6 μm, ≥7 μm, ≥8 μm, ≥9 μm, ≥10 μm, ≥11 μm, ≥12 μm, ≥13 μm, ≥14 μm, or greater. In some embodiments, the thickness of the depressed-index cladding region 43, r₃−r₂, may be less than or equal to (i.e., ≤) 15 μm, ≤14 μm, ≤13 μm, ≤12 μm, ≤11 μm, ≤10 μm, ≤9 μm, ≤8 μm, ≤7 μm, ≤6 μm, ≤5 μm, ≤4 μm, or less than.

In some embodiments, the trench design of the depressed-index cladding region 43 may include a trapezoidal trench or a trapezoidal profile, as shown in FIG. 3. In some embodiments, the trapezoidal trench of the depressed-index cladding region 43 may include a first region 43a and a second region 43b.

In some embodiments, the relative refractive index Δ₃ of the depressed-index cladding region 43 may decrease monotonically in the first region 43a from the inner radius r₂ of the depressed-index cladding region 43 until a minimum value Δ_{3 min} is first reached at the radial position r_{3 min}. Thus, in some embodiments, the relative refractive index Δ₃ of the depressed-index cladding region 43 may become more negative with increasing radius within the first region 43a. In some embodiments, the monotonic decrease in the relative refractive index profile Δ₃ within the first region 43a may exhibit a constant or approximately constant slope. In other words, the relative refractive index profile Δ₃ may decrease linearly with increasing radius in the first region 43a. The first region 43a may also be referred to as the sloped region 43a.

The outer radius of the first region 43a, corresponding to r_{3 min}, may be greater than or equal to (i.e., ≥) 7 μm and less than or equal to (i.e., ≤) 19 μm—including all sub-ranges or values therebetween. For example, in some embodiments, the outer radius of the first region 43a, r_{3 min}, may be ≥7 μm and ≤19 μm, ≥7 μm and 17 μm, ≥7 μm and ≤15 μm, ≥7 μm and ≤13 μm, ≥7 μm and ≤11 μm, ≥7 μm and ≤9 μm, ≥9 μm and ≤19 μm, ≥9 μm and 17 μm, ≥9 μm and ≤15 μm, ≥9 μm and ≤13 μm, ≥9 μm and ≤11 μm, ≥11 μm and ≤19 μm, ≥11 μm and 17 μm, ≥11 μm and ≤15 μm, ≥11 μm and ≤13 μm, ≥13 μm and ≤19 μm, ≥13 μm and 17 μm, ≥13 μm and ≤15 μm, ≥15 μm and ≤19 μm, ≥15 μm and 17 μm, or ≥17 μm and ≤19 μm.

In some embodiments, the outer radius of the first region 43a, r_{3 min}, may be greater than or equal to (i.e., ≥) 7 μm, ≥8 μm, ≥9 μm, ≥10 μm, ≥11 μm, ≥12 μm, ≥13 μm, ≥14 μm, ≥15 μm, ≥16 μm, ≥17 μm, ≥18 μm, or greater. In some embodiments, the outer radius of the first region 43a, r_{3 min}, may be less than or equal to (i.e., ≤) 19 μm, ≤18 μm, ≤17 μm, ≤16 μm, ≤15 μm, ≤14 μm, ≤13 μm, ≤12 μm, ≤11 μm, ≤10 μm, ≤9 μm, ≤8 μm, or less.

In some embodiments, the thickness of the first region 43a as defined by the difference between the radial position r₂ and the radial position r_{3 min}, i.e., r_{3 min}−r₂, may be greater than or equal to (i.e., ≥) 2 μm and less than or equal to (i.e., ≤) 8 μm—including all sub-ranges or values therebetween. For example, in some embodiments, the thickness of the first region 43a, r_{3 min}−r₂, may be ≥2 μm and ≤8 μm, ≥2 μm and ≤7 μm, ≥2 μm and ≤6 μm, ≥2 μm and ≤5 μm, ≥2 μm and ≤4 μm, ≥2 μm and ≤3 μm, ≥3 μm and ≤8 μm, ≥3 μm and ≤7 μm, ≥3 μm and ≤6 μm, ≥3 μm and ≤5 μm, ≥3 μm and ≤4 μm, ≥4 μm and ≤8 μm, ≥4 μm and ≤7 μm, ≥4 μm and ≤6 μm, ≥4 μm and ≤5 μm, ≥5 μm and ≤8 μm, ≥5 μm and ≤7 μm, ≥5 μm and ≤6 μm, ≥6 μm and ≤8 μm, ≥6 μm and ≤7 μm, or ≥7 μm and ≤8 μm.

In some embodiments, the thickness of the first region 43a, r_{3 min}−r₂, may be greater than or equal to (i.e., ≥) 2 μm, ≥3 μm, ≥4 μm, ≥5 μm, ≥6 μm, ≥7 μm, or greater. In some embodiments, the thickness of the first region 43a, r_{3 min}−r₂, may be less than or equal to (i.e., ≤) 8 μm, ≤7 μm, ≤6 μm, ≤5 μm, ≤4 μm, ≤3 μm, or less.

In some embodiments, the relative refractive index Δ₃ of the depressed-index cladding region 43 may be constant or substantially constant in the second region from the radial position r_{3 min} to the outer radius r₃. Thus, the relative refractive index Δ₃ of the depressed-index cladding region 43 may be maintained at Δ_{3 min}. The transition region from the depressed-index cladding region 43 to the outer cladding region 44 is shown as a step change in FIG. 3. However, it is to be understood that the step change may be an idealization and that the transition region may not be strictly vertical in practice. Instead, the transition region may each have a slope or curvature.

The thickness of the second region 43b as defined by the difference between the radial position r_{3 min} corresponding to the inner radius of the second region 43b and the radial position r₃ corresponding to the outer radius of the second region 43b, i.e., r₃−r_{3 min}, may be greater than or equal to (i.e., ≥) 1 μm and less than or equal to (i.e., ≤) 7 μm—including all sub-ranges or values therebetween. For example, in some embodiments, the thickness of the second region 43b, r₃−r_{3 min}, may be ≥1 μm and ≤7 μm, ≥1 μm and ≤6 μm, ≥1 μm and ≤5 μm, ≥1 μm and ≤4 μm, ≥1 μm and ≤3 μm, ≥1 μm and ≤2 μm, ≥2 μm and ≤7 μm, ≥2 μm and ≤6 μm, ≥2 μm and ≤5 μm, ≥2 μm and ≤4 μm, ≥2 μm and ≤3 μm, ≥3 μm and ≤7 μm, ≥3 μm and ≤6 μm, ≥3 μm and ≤5 μm, ≥3 μm and ≤4 μm, ≥4 μm and ≤7 μm, ≥4 μm and ≤6 μm, ≥4 μm and ≤5 μm, ≥5 μm and ≤7 μm, ≥5 μm and ≤6 μm, or ≥6 μm and ≤7 μm.

In some embodiments, the thickness of the second region 43b, r₃−r_{3 min}, may be greater than or equal to (i.e., ≥) 1 μm, ≥2 μm, ≥3 μm, ≥4 μm, ≥5 μm, ≥6 μm, or greater. In some embodiments, the thickness of the second region 43b, r₃−r_{3 min}, may be less than or equal to (i.e., ≤) 7 μm, ≤6 μm, ≤5 μm, ≤4 μm, ≤3 μm, ≤2 μm, or less.

In some embodiments, the minimum relative refractive index Δ_{3 min} may be greater than or equal to (i.e., ≥) −0.6% and less than or equal to (i.e., ≤) −0.4%—including all sub-ranges or values therebetween. For example, in some embodiments, the minimum relative refractive index Δ_{3 min} may be ≥−0.6% and ≤−0.4%, ≥−0.6% and ≤−0.45%, ≥−0.6% and ≤−0.5%, ≥−0.6% and ≤−0.55%, ≥−0.55% and ≤−0.4%, ≥−0.55% and ≤−0.45%, ≥−0.55% and ≤−0.5%, ≥−0.5% and ≤−0.4%, ≥−0.5% and ≤−0.45%, or ≥−0.45% and ≤−0.4%. In some embodiments, the minimum relative refractive index Δ_{3 min} may be greater than or equal to (i.e., ≥) −0.6%, ≥−0.58%, ≥−0.56%, ≥−0.54%, ≥−0.52%, ≥−0.5%, ≥−0.48%, ≥−0.46%, ≥−0.44%, ≥−0.42%, or greater. In some embodiments, the minimum relative refractive index Δ_{3 min} may be less than or equal to (i.e., ≤) −0.4%, ≤−0.42%, ≤−0.44%, ≤−0.46%, ≤−0.48%, ≤−0.5%, ≤−0.52%, ≤−0.54%, ≤−0.56%, ≤−0.58%, or less.

In some embodiments, the trench volume, in absolute value |V₃|, of the depressed-index cladding region 43 may be greater than or equal to (i.e., ≥) 30%-micron² and less than or equal to (i.e., ≤) 70%-micron²—including all sub-ranges or values therebetween. For example, in some embodiments, the trench volume |V₃| of the depressed-index cladding region 43 may be ≥30%-micron² and ≤70%-micron², ≥30%-micron² and ≤65%-micron², ≥30%-micron² and ≤60%-micron², ≥30%-micron² and ≤55%-micron², ≥30%-micron² and ≤50%-micron², ≥30%-micron² and ≤45%-micron², ≥30%-micron² and ≤40%-micron², ≥30%-micron² and ≤35%-micron², ≥35%-micron² and ≤70%-micron², ≥35%-micron² and ≤65%-micron², ≥35%-micron² and ≤60%-micron², ≥35%-micron² and ≤55%-micron², ≥35%-micron² and ≤50%-micron², ≥35%-micron² and ≤45%-micron², ≥35%-micron² and ≤40%-micron², ≥40%-micron² and ≤70%-micron², ≥40%-micron² and ≤65%-micron², ≥40%-micron² and ≤60%-micron², ≥40%-micron² and ≤55%-micron², ≥40%-micron² and ≤50%-micron², ≥40%-micron² and ≤45%-micron², ≥45%-micron² and ≤70%-micron², ≥45%-micron² and ≤65%-micron², ≥45%-micron² and ≤60%-micron², ≥45%-micron² and ≤55%-micron², ≥45%-micron² and ≤50%-micron², ≥50%-micron² and ≤70%-micron², ≥50%-micron² and ≤65%-micron², ≥50%-micron² and ≤60%-micron², ≥50%-micron² and ≤55%-micron², ≥55%-micron² and ≤70%-micron², ≥55%-micron² and ≤65%-micron², ≥55%-micron² and ≤60%-micron², ≥60%-micron² and ≤70%-micron², ≥60%-micron² and ≤65%-micron^{2,} or ≥65%-micron² and ≤70%-micron².

In some embodiments, the trench volume |V₃| of the depressed-index cladding region 43 may be greater than or equal to (i.e., ≥) 30%-micron², ≥35%-micron², ≥40%-micron², ≥45%-micron², ≥50%-micron², ≥55%-micron², ≥60%-micron², ≥65%-micron², or greater. In some embodiments, the trench volume |V₃| of the depressed-index cladding region 43 may be less than or equal to (i.e., ≤) 70%-micron², ≤65%-micron², ≤60%-micron², ≤55%-micron², ≤50%-micron², ≤45%-micron², ≤40%-micron², ≤35%-micron², or less.

Without intending to be limited by theory, the offset, trapezoidal trench design described herein, may at least in part further lower the microbend loss. When compared to a triangular trench design, the second region 43b of the trapezoidal trench design described herein, in which the minimum relative refractive index Δ_{3 min} may be maintained constant or substantially constant, may allow a greater trench volume |V₃| to be achieved for lowing microbend loss without requiring further increasing the outer radius r₃ of the depressed-index cladding region 43 and/or further decreasing the minimum relative refractive index Δ_{3 min}. As discussed above, up to 70%-micron² of trench volume |V₃ | may be achieved using the trapezoidal trench design described herein while employing an outer radius r₃ of ≤20 μm and/or a minimum relative refractive index Δ_{3 min}≥−0.6%. The increased trench volume |V₃| may further confine the light in the depressed-index cladding region 43, thereby lowering optical power leakage beyond the depressed-index cladding region 43 to mitigate microbend loss experienced in high-density cables. The trench volume |V₃| may be maintained ≤70%-micron² such that a cutoff wavelength of ≤1260 nm may be achieved. The inventors have found that a range of 30%-micron² to 70%-micron² of the trench volume |V₃| may offer the advantageous low microbend loss property while maintaining a low cutoff wavelength and providing manufacturing case and flexibility.

In addition to the low microbend loss and the low cutoff wavelength, the offset, trapezoidal trench design also helps to achieve a large mode field diameter, low macrobend loss, and/or dispersion characteristics that meet or exceed the G.657.A2 standard.

As discussed above, the depressed-index cladding region 43 is offset from the core region 30 by a distance of at least 1 μm. As the offset distance between the core region 30 and the depressed-index cladding region 43 is decreased, the diameter of the core region 30 may need to be increased to maintain the same mode field diameter, and the increase in the diameter of the core region 30 may lead to an increase in the microbend loss. Thus, the offset distance may be configured to be at least 1 μm such that a mode field diameter of ≥9 μm may be achieved while reducing the microbend loss. Additionally, an offset distance of at least 1 μm may also help to ensure a zero dispersion wavelength between 1300 nm and 1324 nm. As also discussed above, the offset distance may not exceed 10 μm such that the macrobend performance may not be compromised.

Thus, the offset, trapezoidal design of the depressed-index cladding region 43 is optimized to achieve low microbend loss, while also maintaining low macrobend loss, the low cable cutoff values, and/or a zero dispersion wavelength between 1300 nm and 1324 nm.

### Outer Cladding Region

The outer cladding region 44 may include un-doped silica glass. In some embodiments, the outer cladding region 44 may be the outermost glass layer of the glass fiber 20. Accordingly, the outer radius r₄ of the outer cladding region 44 also corresponds to the outer radius r₄ of the glass fiber 20. The inner radius r₃ of the outer cladding region 44 may correspond to the outer radius r₃ of the depressed-index cladding region 43, as discussed above.

The relative refractive index profile of the glass fiber 20 described herein may be implemented for glass fibers having relatively large glass diameters (e.g., about 125 μm) or relatively small glass diameters (e.g., ≥80 μm and ≤120 μm). Thus, in some embodiments, the diameter of the glass fiber 20 may be greater than or equal to (i.e., ≥) 80 μm and less than or equal to (i.e., ≤) 130 μm—including all sub-ranges or values therebetween. For example, in some embodiments, the diameter of the glass fiber 20 may be ≥80 μm and ≤130 μm, ≥80 μm and ≤125 μm, ≥80 μm and ≤120 μm, ≥80 μm and ≤115 μm, ≥80 μm and ≤110 μm, ≥80 μm and ≤100 μm, ≥80 μm and ≤90 μm, ≥90 μm and ≤130 μm, ≥90 μm and ≤125 μm, ≥90 μm and ≤120 μm, ≥90 μm and ≤115 μm, ≥90 μm and ≤110 μm, ≥90 μm and ≤100 μm, ≥100 μm and ≤130 μm, ≥100 μm and ≤125 μm, ≥100 μm and ≤120 μm, ≥100 μm and ≤115 μm, ≥100 μm and ≤110 μm, ≥110 μm and ≤130 μm, ≥110 μm and ≤125 μm, ≥110 μm and ≤120 μm, ≥110 μm and ≤115 μm, ≥115 μm and ≤130 μm, ≥115 μm and ≤125 μm, ≥115 μm and ≤120 μm, ≥120 μm and ≤130 μm, ≥120 μm and ≤125 μm, or ≥125 μm and ≤130 μm.

In some embodiments, the diameter of the glass fiber 20 may be greater than or equal to (i.e., ≥) 80 μm, ≥85 μm, ≥90 μm, ≥95 μm, ≥100 μm, ≥105 μm, ≥110 μm, ≥115 μm, ≥120 μm, ≥125 μm, or greater. In some embodiments, the diameter (2×r₄) of the glass fiber 20 may be less than or equal to (i.e., ≤) 130 μm, ≤125 μm, ≤120 μm, ≤115 μm, ≤110 μm, ≤105 μm, ≤100 μm, ≤95 μm, ≤90 μm, ≤85 μm, or less.

The outer radius r₄ of the outer cladding region 44 and/or the outer radius r₄ of the glass fiber 20 when the outer cladding region 44 is the outermost glass layer of the glass fiber 20, may be greater than or equal to (i.e., ≥) 40 μm and less than or equal to (i.e., ≤) 65 μm—including all sub-ranges or values therebetween. For example, in some embodiments, the outer radius r₄ of the outer cladding region 44 and/or the outer radius r₄ of the glass fiber 20 may be ≥40 μm and ≤65 μm, ≥40 μm and ≤62.5 μm, ≥40 μm and ≤60 μm, ≥40 μm and ≤57.5 μm, ≥40 μm and ≤55 μm, ≥40 μm and ≤50 μm, ≥40 μm and ≤45 μm, ≥45 μm and ≤65 μm, ≥45 μm and ≤62.5 μm, ≥45 μm and ≤60 μm, ≥45 μm and ≤57.5 μm, ≥45 μm and ≤55 μm, ≥45 μm and ≤50 μm, ≥50 μm and ≤65 μm, ≥50 μm and ≤62.5 μm, ≥50 μm and ≤60 μm, ≥50 μm and ≤57.5 μm, ≥50 μm and ≤55 μm, ≥55 μm and ≤65 μm, ≥55 μm and ≤62.5 μm, ≥55 μm and ≤60 μm, ≥55 μm and ≤57.5 μm, ≥57.5 μm and ≤65 μm, ≥57.5 μm and ≤62.5 μm, ≥57.5 μm and ≤60 μm, ≥60 μm and ≤65 μm, ≥60 μm and ≤62.5 μm, or ≥62.5 μm and ≤65 μm.

In some embodiments, the outer radius r₄ of the outer cladding region 44 and/or the outer radius r₄ of the glass fiber 20 may be greater than or equal to (i.e., ≥) 40 μm, ≥42.5 μm, ≥45 μm, ≥47.5 μm, ≥50 μm, ≥52.5 μm, ≥55 μm, ≥57.5 μm, ≥60 μm, ≥62.5 μm, or greater. In some embodiments, the outer radius r₄ of the outer cladding region 44 and/or the outer radius r₄ of the glass fiber 20 may be less than or equal to (i.e., ≤) 65 μm, ≤62.5 μm, ≤60 μm, ≤57.5 μm, ≤55 μm, ≤52.5 μm, ≤50 μm, ≤47.5 μm, ≤45 μm, ≤42.5 μm, or less.

The relative refractive index Δ₄ of the outer cladding region 44 may be greater than or equal to (i.e., ≥) −0.10% and less than or equal to (i.e., ≤) 0.10%—including all sub-ranges or values therebetween. For example, in some embodiments, the relative refractive index Δ₄ of the outer cladding region 44 may be ≥−0.10% and ≤0.10%, or ≥−0.05% and ≤0.05%. In some embodiments, the relative refractive index Δ₄ of the outer cladding region 44 may be greater than or equal to (i.e., ≥) −0.10%, ≥−0.05%, or greater. In some embodiments, the relative refractive index Δ₄ of the outer cladding region 44 may be less than or equal to (i.e., ≤) 0.10%, ≤0.05%, or less. In some embodiments, the relative refractive index Δ₄ is about 0.0%. The relative refractive index Δ₄ is preferably constant or approximately constant. Furthermore, in some embodiments, the relative refractive index Δ₄ is equal to or substantially equal to the relative refractive index Δ₂.

### Coatings

In some embodiments, the primary coating 50 may immediately surround and directly contact the glass fiber 20. In some embodiments, the inner radius r₄ of the primary coating 50 may correspond to the outer radius r₄ of the outer cladding region 44, as discussed above. In some embodiments, the outer radius r₅ of the primary coating 50 may be greater than or equal to (i.e., ≥) 62.5 μm and less than or equal to (i.e., ≤) 97.5 μm—including all sub-ranges or values therebetween. For example, in some embodiments, the outer radius r₅ of the primary coating 50 may be ≥62.5 μm and ≤97.5 μm, ≥62.5 μm and ≤92.5 μm, ≥62.5 μm and ≤87.5 μm, ≥62.5 μm and ≤82.5 μm, ≥62.5 μm and ≤77.5 μm, ≥62.5 μm and ≤72.5 μm, ≥62.5 μm and ≤67.5 μm, ≥67.5 μm and ≤97.5 μm, ≥67.5 μm and ≤92.5 μm, ≥67.5 μm and ≤87.5 μm, ≥67.5 μm and ≤82.5 μm, ≥67.5 μm and ≤77.5 μm, ≥67.5 μm and ≤72.5 μm, ≥72.5 μm and ≤97.5 μm, ≥72.5 μm and ≤92.5 μm, ≥72.5 μm and ≤87.5 μm, ≥72.5 μm and ≤82.5 μm, ≥72.5 μm and ≤77.5 μm, ≥77.5 μm and ≤97.5 μm, ≥77.5 μm and ≤92.5 μm, ≥77.5 μm and ≤87.5 μm, ≥77.5 μm and ≤82.5 μm, ≥82.5 μm and ≤97.5 μm, ≥82.5 μm and ≤92.5 μm, ≥82.5 μm and ≤87.5 μm, ≥87.5 μm and ≤97.5 μm, ≥87.5 μm and ≤92.5 μm, or ≥92.5 μm and ≤97.5 μm.

In some embodiments, the outer radius r₅ of the primary coating 50 may be greater than or equal to (i.e., ≥) 62.5 μm, ≥67.5 μm, ≥72.5 μm, ≥77.5 μm, ≥82.5 μm, ≥87.5 μm, ≥92.5 μm, ≥97 μm, or greater. In some embodiments, the outer radius r₅ of the primary coating 50 may be less than or equal to (i.e., ≤) 97.5 μm, ≤92.5 μm, ≤87.5 μm, ≤82.5 μm, ≤77.5 μm, ≤72.5 μm, ≤67.5 μm, ≤62 μm, or less.

In some embodiments, the primary coating 50 may include a low modulus material. In some embodiments, the primary coating 50 may have an in-situ modulus greater than or equal to (i.e., ≥) 0.15 MPa and less than or equal to (i.e., ≤) 0.5 MPa—including all sub-ranges or values therebetween. For example, in some embodiments, the primary coating 50 may have an in-situ modulus ≥0.15 MPa and ≤0.5 MPa, ≥0.15 MPa and ≤0.45 MPa, ≥0.15 MPa and ≤0.4 MPa, ≥0.15 MPa and ≤0.35 MPa, ≥0.15 MPa and ≤0.3 MPa, ≥0.15 MPa and ≤0.25 MPa, ≥0.15 MPa and ≤0.2 MPa, ≥0.2 MPa and ≤0.5 MPa, ≥0.2 MPa and ≤0.45 MPa, ≥0.2 MPa and ≤0.4 MPa, ≥0.2 MPa and ≤0.35 MPa, ≥0.2 MPa and ≤0.3 MPa, ≥0.2 MPa and ≤0.25 MPa, ≥0.25 MPa and ≤0.5 MPa, ≥0.25 MPa and ≤0.45 MPa, ≥0.25 MPa and ≤0.4 MPa, ≥0.25 MPa and ≤0.35 MPa, ≥0.25 MPa and ≤0.3 MPa, ≥0.3 MPa and ≤0.5 MPa, ≥0.3 MPa and ≤0.45 MPa, ≥0.3 MPa and ≤0.4 MPa, ≥0.3 MPa and ≤0.35 MPa, ≥0.35 MPa and ≤0.5 MPa, ≥0.35 MPa and ≤0.45 MPa, ≥0.35 MPa and ≤0.4 MPa, ≥0.4 MPa and ≤0.5 MPa, ≥0.4 MPa and ≤0.45 MPa, or ≥0.45 MPa and ≤0.5 MPa.

In some embodiments, the primary coating 50 may have an in-situ modulus greater than or equal to (i.e., ≥) 0.15 MPa, ≥0.2 MPa, ≥0.25 MPa, ≥0.3 MPa, ≥0.35 MPa, ≥0.4 MPa, ≥0.45 MPa, or greater. In some embodiments, the primary coating 50 may have an in-situ modulus less than or equal to (i.e., ≤) 0.5 MPa, ≤0.45 MPa, ≤0.4 MPa, ≤0.35 MPa, ≤0.3 MPa, ≤0.25 MPa, ≤0.2 MPa, or less than.

In some embodiments, the secondary coating 60 may immediately surround and directly contact the primary coating 50. In some embodiments, the inner radius r₅ of the secondary coating 60 may correspond to the outer radius r₅ of the primary coating 50, as discussed above. In some embodiments, the outer radius r₆ of the secondary coating 60 may be greater than or equal to (i.e., ≥) 80 μm and less than or equal to (i.e., ≤) 125 μm—including all sub-ranges or values therebetween. For example, in some embodiments, the outer radius r₆ of the secondary coating 60 may be ≥80 μm and ≤125 μm, ≥80 μm and ≤115 μm, ≥80 μm and ≤105 μm, ≥80 μm and ≤95 μm, ≥90 μm and ≤125 μm, ≥90 μm and ≤115 μm, ≥90 μm and ≤105 μm, ≥90 μm and ≤95 μm, ≥100 μm and ≤125 μm, ≥100 μm and ≤115 μm, ≥100 μm and ≤105 μm, ≥110 μm and ≤125 μm, ≥110 μm and ≤115 μm, or ≥120 μm and ≤125 μm.

In some embodiments, the outer radius r₆ of the secondary coating 60 may be greater than or equal to (i.e., ≥) 80 μm, ≥85 μm, ≥90 μm, ≥95 μm, ≥100 μm, ≥105 μm, ≥110 μm, ≥115 μm, ≥120 μm, ≥125 μm, or greater. In some embodiments, the outer radius r₆ of the secondary coating 60 may be less than or equal to (i.e., ≤) 125 μm, ≤120 μm, ≤115 μm, ≤110 μm, ≤105 μm, ≤100 μm, ≤95 μm, ≤90 μm, ≤85 μm, or less.

In some embodiments, the secondary coating 60 may include a high modulus material. In some embodiments, the secondary coating 60 may have an in-situ modulus greater than or equal to (i.e., ≥) 1500 MPa and less than or equal to (i.e., ≤) 2500 MPa—including all sub-ranges or values therebetween. For example, in some embodiments, the secondary coating 60 may have an in-situ modulus ≥1500 MPa and ≤2500 MPa, ≥1500 MPa and ≤2300 MPa, ≥1500 MPa and ≤2100 MPa, ≥1500 MPa and ≤1900 MPa, ≥1500 MPa and ≤1700 MPa, ≥1700 MPa and ≤2500 MPa, ≥1700 MPa and ≤2300 MPa, ≥1700 MPa and ≤2100 MPa, ≥1700 MPa and ≤1900 MPa, ≥1900 MPa and ≤2500 MPa, ≥1900 MPa and ≤2300 MPa, ≥1900 MPa and ≤2100 MPa, ≥2100 MPa and ≤2500 MPa, ≥2100 MPa and ≤2300 MPa, or ≥2300 MPa and ≤2500 MPa.

In some embodiments, the secondary coating 60 may have an in-situ modulus greater than or equal to (i.e., ≥) 1500 MPa, ≥1600 MPa, ≥1700 MPa, ≥1800 MPa, ≥1900 MPa, ≥2000 MPa, ≥2100 MPa, ≥2200 MPa, ≥2300 MPa, ≥2400 MPa, or greater. In some embodiments, the secondary coating 60 may have an in-situ modulus less than or equal to (i.e., ≤) 2500 MPa, ≤2400 MPa, ≤2300 MPa, ≤2200 MPa, ≤2100 MPa, ≤2000 MPa, ≤1900 MPa, ≤1800 MPa, ≤1700 MPa, ≤1600 MPa, or less.

In some embodiments, a thickness of the primary coating 50 as defined by the difference between the radial position r₅ and the radial position r₄, i.e., r₅−r₄, may be greater than or equal to (i.e., ≥) 10 μm and less than or equal to (i.e., ≤) 50 μm—including all sub-ranges or values therebetween. For example, in some embodiments, the thickness of the primary coating 50, r₅−r₄, may be ≥10 μm and ≤50 μm, ≥10 μm and ≤45 μm, ≥10 μm and ≤40 μm, ≥10 μm and ≤35 μm, ≥10 μm and ≤30 μm, ≥10 μm and ≤25 μm, ≥10 μm and ≤20 μm, ≥10 μm and ≤15 μm, ≥15 μm and ≤50 μm, ≥15 μm and ≤45 μm, ≥15 μm and ≤40 μm, ≥15 μm and ≤35 μm, ≥15 μm and ≤30 μm, ≥15 μm and ≤25 μm, ≥15 μm and ≤20 μm, ≥20 μm and ≤50 μm, ≥20 μm and ≤45 μm, ≥20 μm and ≤40 μm, ≥20 μm and ≤35 μm, ≥20 μm and ≤30 μm, ≥20 μm and ≤25 μm, ≥25 μm and ≤50 μm, ≥25 μm and ≤45 μm, ≥25 μm and ≤40 μm, ≥25 μm and ≤35 μm, ≥25 μm and ≤30 μm, ≥30 μm and ≤50 μm, ≥30 μm and ≤45 μm, ≥30 μm and ≤40 μm, ≥30 μm and ≤35 μm, ≥35 μm and ≤50 μm, ≥35 μm and ≤45 μm, ≥35 μm and ≤40 μm, ≥40 μm and ≤50 μm, ≥40 μm and ≤45 μm, or ≥45 μm and ≤50 μm.

In some embodiments, the thickness of the primary coating 50, r₅−r₄, may be greater than or equal to (i.e., ≥) 10 μm, ≥15 μm, ≥20 μm, ≥25 μm, ≥30 μm, ≥35 μm, ≥40 μm, ≥45 μm, or greater. In some embodiments, the thickness of the primary coating 50, r₅−r₄, may be less than or equal to (i.e., ≤) 50 μm, ≤45 μm, ≤40 μm, ≤35 μm, ≤30 μm, ≤25 μm, ≤20 μm, ≤15 μm, or less.

In some embodiments, a thickness of the secondary coating 60 as defined by the difference between the radial position r₆ and the radial position r₅, i.e., r₆−r₅, may be greater than or equal to (i.e., ≥) 8 μm and less than or equal to (i.e., ≤) 40 μm—including all sub-ranges or values therebetween. For example, in some embodiments, the thickness of the secondary coating 60, r₆−r₅, may be ≥8 μm and ≤40 μm, ≥8 μm and ≤36 μm, ≥8 and ≤32 μm, ≥8 and ≤28 μm, ≥8 and ≤24 μm, ≥8 and ≤20 μm, ≥8 and ≤16 μm, ≥8 and ≤12 μm, ≥12 μm and ≤40 μm, ≥12 μm and ≤36 μm, ≥12 and ≤32 μm, ≥12 and ≤28 μm, ≥12 and ≤24 μm, ≥12 and ≤20 μm, ≥12 and ≤16 μm, ≥16 μm and ≤40 μm, ≥16 μm and ≤36 μm, ≥16 and ≤32 μm, ≥16 and ≤28 μm, ≥16 and ≤24 μm, ≥16 and ≤20 μm, ≥20 μm and ≤40 μm, ≥20 μm and ≤36 μm, ≥20 and ≤32 μm, ≥20 and ≤28 μm, ≥20 and ≤24 μm, ≥24 μm and ≤40 μm, ≥24 μm and ≤36 μm, ≥24 and ≤32 μm, ≥24 and ≤28 μm, ≥28 μm and ≤40 μm, ≥28 μm and ≤36 μm, ≥28 and ≤32 μm, ≥32 μm and ≤40 μm, ≥32 μm and ≤36 μm, or ≥36 μm and ≤40 μm.

In some embodiments, the thickness of the secondary coating 60, r₆−r₅, may be greater than or equal to (i.e., ≥) 8 μm, ≥10 μm, ≥12 μm, ≥14 μm, ≥16 μm, ≥18 μm, ≥20 μm, ≥22 μm, ≥24 μm, ≥26 μm, ≥28 μm, ≥30 μm, ≥32 μm, ≥34 μm, ≥36 μm, ≥38 μm, or greater. In some embodiments, the thickness of the secondary coating 60, r₆−r₅, may be less than or equal to (i.e., ≤) 40 μm, ≤38 μm, ≤36 μm, ≤34 μm, ≤32 μm, ≤30 μm, ≤28 μm, ≤26 μm, ≤24 μm, ≤22 μm, ≤20 μm, ≤18 μm, ≤16 μm, ≤14 μm, ≤12 μm, ≤10 μm, or less.

In some embodiments, a ratio of the thickness of the primary coating 50 to the thickness of the secondary coating 60 may be greater than or equal to (i.e., ≥) 0.8 and less than or equal to (i.e., ≤) 1.2—including all sub-ranges or values therebetween. For example, in some embodiments, the ratio of the thickness of the primary coating 50 to the thickness of the secondary coating 60 may be ≥0.8 and ≤1.2, ≥0.8 and ≤1.1, ≥0.8 and ≤1, ≥0.8 and ≤0.9, ≥0.9 and ≤1.2, ≥0.9 and ≤1.1, ≥0.9 and ≤1, ≥1 and ≤1.2, ≥1 and ≤1.1, or ≥1.1 and ≤1.2. In some embodiments, the ratio of the thickness of the primary coating 50 to the thickness of the secondary coating 60 may be greater than or equal to (i.e., ≥) 0.8, ≥0.85, ≥0.9, ≥0.95, ≥1, ≥1.05, ≥1.1, ≥1.15, or greater. In some embodiments, the ratio of the thickness of the primary coating 50 to the thickness of the secondary coating 60 may be less than or equal to (i.e., ≤) 1.2, ≤1.15, ≤1.1, ≤1.05, ≤1, ≤0.95, ≤9, ≤0.85, or less.

In some embodiments, the optical fiber 10 may also include a tertiary coating that may immediately surround and directly contact the secondary coating 60. The tertiary coating may include pigments, inks, or other coloring agents to mark the optical fiber for identification purposes and typically has a Young's modulus similar to the Young's modulus of the secondary coating.

The outer diameter/radius of the optical fiber 10 and/or the coating 70 correspond to the outer diameter/radius of the outermost coating layer. In some embodiments, the secondary coating 60 may be the outermost coating of the optical fiber 10, and the outer diameter of the secondary coating 60 corresponds to the outer diameter of the optical fiber 10 and/or the coating 70. In some embodiments, the tertiary coating may be the outermost coating layer of the optical fiber 10, and the outer diameter of the tertiary coating corresponds to the outer diameter of the optical fiber 10 and/or the coating 70.

In some embodiments, the outer diameter of the coated optical fiber 10 and/or the coating 70 may be greater than or equal to (i.e., ≥) 160 μm and less than or equal to (i.e., ≤) 250 μm—including all sub-ranges or values therebetween. For example, in some embodiments, the outer diameter of the coated optical fiber 10 and/or the coating 70 may be ≥160 μm and ≤250 μm, ≥160 μm and ≤240 μm, ≥160 μm and ≤230 μm, ≥160 μm and ≤220 μm, ≥160 μm and ≤210 μm, ≥160 μm and ≤200 μm, ≥160 μm and ≤190 μm, ≥160 μm and ≤180 μm, ≥160 μm and ≤170 μm, ≥170 μm and ≤250 μm, ≥170 μm and ≤240 μm, ≥170 μm and ≤230 μm, ≥170 μm and ≤220 μm, ≥170 μm and ≤210 μm, ≥170 μm and ≤200 μm, ≥170 μm and ≤190 μm, ≥170 μm and ≤180 μm, ≥180 μm and ≤250 μm, ≥180 μm and ≤240 μm, ≥180 μm and ≤230 μm, ≥180 μm and ≤220 μm, ≥180 μm and ≤210 μm, ≥180 μm and ≤200 μm, ≥180 μm and ≤190 μm, ≥190 μm and ≤250 μm, ≥190 μm and ≤240 μm, ≥190 μm and ≤230 μm, ≥190 μm and ≤220 μm, ≥190 μm and ≤210 μm, ≥190 μm and ≤200 μm, ≥200 μm and ≤250 μm, ≥200 μm and ≤240 μm, ≥200 μm and ≤230 μm, ≥200 μm and ≤220 μm, ≥200 μm and ≤210 μm, ≥210 μm and ≤250 μm, ≥210 μm and ≤240 μm, ≥210 μm and ≤230 μm, ≥210 μm and ≤220 μm, ≥220 μm and ≤250 μm, ≥220 μm and ≤240 μm, ≥220 μm and ≤230 μm, ≥230 μm and ≤250 μm, ≥230 μm and ≤240 μm, or ≥240 μm and ≤250 μm.

In some embodiments, the outer diameter of the coated optical fiber 10 and/or the coating 70 may be greater than or equal to (i.e., ≥) 160 μm, ≥170 μm, ≥180 μm, ≥190 μm, ≥200 μm, ≥210 μm, ≥220 μm, ≥230 μm, ≥240 μm, ≥245 μm, or greater. In some embodiments, the outer diameter of the coated optical fiber 10 and/or the coating 70 may be less than or equal to (i.e., ≤) 250 μm, ≤240 μm, ≤230 μm, ≤220 μm, ≤210 μm, ≤200 μm, ≤190 μm, ≤180 μm, ≤170 μm, ≤165 μm, or less.

### Fiber Attributes

As discussed above, the optical fibers disclosed herein have advantageous properties of low microbend loss while also achieving low cutoff with a large mode field diameter, low macrobend loss, and/or dispersion characteristics meeting or exceeding the G.657.A2 standard.

The optical fibers described herein can be used advantageously for high fiber density cables in data center interconnects and smaller diameter cables in congested duct applications to minimize attenuation change, which can be associated with the increase in microbend loss induced due to shrinking and expansion of cables during thermal cycling. For example, when used in high density cables having a fiber density greater than or equal to 6 fibers/mm², or in some instances, greater than or equal to 8 fibers/mm², the optical fibers described herein exhibit attenuation change of less than 0.15 dB/km at 1550 nm when the cables are thermal cycled multiple times between temperatures of −40° C. and 70° C.

For example, when used in high density cables having a fiber density greater than or equal to 6 fibers/mm², the optical fibers described herein exhibit attenuation change of less than 0.15 dB/km, less than 0.14 dB/km, less than 0.12 dB/km, less than 0.1 dB/km, less than 0.08 dB/km, less than 0.06 dB/km, less than 0.04 dB/km, or less, at 1550 nm when the cables are thermal cycled multiple times between temperatures of −40° C. and 70° C. When used in high density cables having a fiber density greater than or equal to 8 fibers/mm², the optical fibers described herein exhibit attenuation change of less than 0.15 dB/km, less than 0.14 dB/km, less than 0.12 dB/km, less than 0.1 dB/km, less than 0.08 dB/km, less than 0.06 dB/km, or less, at 1550 nm when the cables are thermal cycled multiple times between temperatures of −40° C. and 70° C.

### Microbend Loss

In some embodiments, the optical fibers disclosed herein may exhibit a microbend loss, at 1625 nm wavelength, less than or equal to (i.e., ≤) 1.5 dB/km, ≤1.3 dB/km, ≤1.1 dB/km, ≤0.9 dB/km, ≤0.7 dB/km, ≤0.5 dB/km, or less.

In some embodiments, the optical fibers disclosed herein may exhibit a microbend loss, at 1550 nm wavelength, less than or equal to (i.e., ≤) 1.2 dB/km, ≤1 dB/km, ≤0.8 dB/km, ≤0.6 dB/km, ≤0.4 dB/km, or less.

In some embodiments, the optical fibers disclosed herein may exhibit a microbend loss, at 1310 nm wavelength, less than or equal to (i.e., ≤) 1 dB/km, ≤0.9 dB/km, ≤0.8 dB/km, ≤0.7 dB/km, ≤0.6 dB/km, ≤0.5 dB/km, ≤0.4 dB/km, or less.

### Macrobend Loss

In addition to low microbend loss, the optical fibers disclosed herein also exhibit excellent macrobend performance. In some embodiments, the optical fibers disclosed herein may exhibit a macrobend loss, at 1310 nm wavelength, less than or equal to (i.e., ≤) 0.02 dB/turn, ≤0.015 dB/turn, ≤0.01 dB/turn, or ≤0.005 dB/turn, as determined by the mandrel wrap test having a diameter of 15 mm.

In some embodiments, the optical fibers disclosed herein may exhibit a macrobend loss, at 1310 nm wavelength, less than or equal to (i.e., ≤) 0.002 dB/turn, ≤0.0015 dB/turn, ≤0.001 dB/turn, or ≤0.0005 dB/turn, as determined by the mandrel wrap test having a diameter of 20 mm.

In some embodiments, the optical fibers disclosed herein may exhibit a macrobend loss, at 1310 nm wavelength, less than or equal to (i.e., ≤) 5e-5 dB/turn, ≤2e-5 dB/turn, or ≤1e-5 dB/turn, as determined by the mandrel wrap test having a diameter of 30mm.

In some embodiments, the optical fibers disclosed herein may exhibit a macrobend loss, at 1550 nm wavelength, less than or equal to (i.e., ≤) 0.5 dB/turn, ≤0.25 dB/turn, ≤0.15 dB/turn, ≤0.1 dB/turn, ≤0.09 dB/turn, ≤0.08 dB/turn, ≤0.07 dB/turn, or ≤0.06 dB/turn, as determined by the mandrel wrap test having a diameter of 15 mm.

In some embodiments, the optical fibers disclosed herein may exhibit a macrobend loss, at 1550 nm wavelength, less than or equal to (i.e., ≤) 0.11 dB/turn, ≤0.1 dB/turn, ≤0.09 dB/turn, ≤0.08 dB/turn, ≤0.07 dB/turn, ≤0.06 dB/turn, 0.05 dB/turn, or ≤0.04 dB/turn, as determined by the mandrel wrap test having a diameter of 20 mm.

In some embodiments, the optical fibers disclosed herein may exhibit a macrobend loss, at 1550 nm wavelength, less than or equal to (i.e., ≤) 0.02 dB/turn, ≤0.01 dB/turn, ≤0.009 dB/turn, ≤0.008 dB/turn, ≤0.007 dB/turn, ≤0.006 dB/turn, ≤0.005 dB/turn, ≤0.004 dB/turn, or ≤0.003 dB/turn, as determined by the mandrel wrap test having a diameter of 30 mm.

In some embodiments, the optical fibers disclosed herein may exhibit a macrobend loss, at 1625 nm wavelength, less than or equal to (i.e., ≤) 0.5 dB/turn, ≤0.4 dB/turn, ≤0.3 dB/turn, ≤0.2 dB/turn, ≤0.18 dB/turn, ≤0.16 dB/turn, or ≤0.14 dB/turn, as determined by the mandrel wrap test having a diameter of 15 mm.

In some embodiments, the optical fibers disclosed herein may exhibit a macrobend loss, at 1625 nm wavelength, less than or equal to (i.e., ≤) 0.4 dB/turn, ≤0.3 dB/turn, ≤0.2 dB/turn, ≤0.18 dB/turn, ≤0.16 dB/turn, ≤0.14 dB/turn, or ≤0.12 dB/turn, as determined by the mandrel wrap test having a diameter of 20 mm.

In some embodiments, the optical fibers disclosed herein may exhibit a macrobend loss, at 1625 nm wavelength, less than or equal to (i.e., ≤) 0.06 dB/turn, ≤0.04 dB/turn, ≤0.02 dB/turn, ≤0.01 dB/turn, ≤0.009 dB/turn, ≤0.007 dB/turn, or ≤0.005 dB/turn, as determined by the mandrel wrap test having a diameter of 30 mm.

### Mode Field Diameter (MFD)

In addition to low macrobend loss and low microbend loss, the optical fibers disclosed herein also maintain a large mode field diameter. In some embodiments, the optical fibers disclosed herein may include a mode field diameter, at 1310 nm wavelength, greater than or equal to (i.e., ≥) 9.0 μm, ≥9.1 μm, ≥9.2 μm, ≥9.3 μm, ≥9.4 μm, ≥9.5 μm, ≥9.6μm, or greater. In some embodiments, the optical fibers disclosed herein may include a mode field diameter, at 1310 wavelength, greater than or equal to (i.e., ≥) 9.0 μm and less than or equal to (i.e., ≤) 9.7 μm—including all sub-ranges or values therebetween. For example, in some embodiments, the optical fibers disclosed herein may include a mode field diameter, at 1310 wavelength, ≥9.0 μm and ≤9.7 μm, ≥9.0 μm and ≤9.6 μm, ≥9.0 μm and ≤9.5 μm, ≥9.0 μm and ≤9.4 μm, ≥9.0 μm and ≤9.3 μm, ≥9.0 μm and ≤9.2 μm, ≥9.0 μm and ≤9.1μm, ≥9.1 μm and ≤9.7 μm, ≥9.1 μm and ≤9.6 μm, ≥9.1 μm and ≤9.5 μm, ≥9.1 μm and ≤9.4 μm, ≥9.1 μm and ≤9.3 μm, ≥9.1 μm and ≤9.2 μm, ≥9.2 μm and ≤9.7 μm, ≥9.2 μm and ≤9.6 μm, ≥9.2 μm and ≤9.5 μm, ≥9.2 μm and ≤9.4 μm, ≥9.2 μm and ≤9.3 μm, ≥9.3 μm and ≤9.7 μm, ≥9.3 μm and ≤9.6 μm, ≥9.3 μm and ≤9.5 μm, ≥9.3 μm and ≤9.4 μm, ≥9.4 μm and ≤9.7 μm, ≥9.4 μm and ≤9.6 μm, ≥9.4 μm and ≤9.5 μm, ≥9.5 μm and ≤9.7 μm, ≥9.5 μm and ≤9.6 μm, or ≥9.6 μm and ≤9.7 μm.

In some embodiments, the optical fibers disclosed herein may include a mode field diameter, at 1550 nm wavelength, greater than or equal to (i.e., ≥) 10 μm and less than or equal to (i.e., ≤) 11 μm—including all sub-ranges or values therebetween. For example, in some embodiments, the optical fibers disclosed herein may include a mode field diameter, at 1550 nm wavelength, ≥10 μm and ≤11 μm, ≥10 μm and ≤10.5 μm, or ≥10.5 μm and ≤11 μm. In some embodiments, the optical fibers disclosed herein may include a mode field diameter, at 1550 nm wavelength, greater than or equal to (i.e., ≥) 10 μm, ≥10.25 μm, ≥10.5 μm, ≥10.75 μm or greater. In some embodiments, the optical fibers disclosed herein may include a mode field diameter, at 1550 nm wavelength, less than or equal to (i.e., ≤) 11 μm, ≤10.75 μm, ≤10.5 μm, ≤10.25, or less.

### Cable Cutoff

Furthermore, the optical fibers disclosed herein may exhibit a 22 m cable cutoff less than or equal to (i.e., ≤) 1260 nm, ≤1250 nm, ≤1240 nm, ≤1230 nm, ≤1220 nm, ≤1210 nm, ≤1200 nm, ≤1190 nm, ≤1180 nm, ≤1170 nm, ≤1160 nm, or less. In some embodiments, the optical fibers disclosed herein may exhibit a 22 m cable cutoff greater than or equal to (i.e., ≥) 1150 nm and less than or equal to (i.e., ≤) 1260 nm—including all sub-ranges or values therebetween. For example, in some embodiments, the optical fibers disclosed herein may exhibit a 22 m cable cutoff ≥1150 nm and ≤1260 nm, ≥1150 nm and ≤1240 nm, ≥1150 nm and ≤1220 nm, ≥1150 nm and ≤1200 nm, ≥1150 nm and ≤1180 nm, ≥1150 nm and ≤1160 nm, ≥1160 nm and ≤1260 nm, ≥1160 nm and ≤1240 nm, ≥1160 nm and ≤1220 nm, ≥1160 nm and ≤1200 nm, ≥1160 nm and ≤1180 nm, ≥1180 nm and ≤1260 nm, ≥1180 nm and ≤1240 nm, ≥1180 nm and ≤1220 nm, ≥1180 nm and ≤1200 nm, ≥1200 nm and ≤1260 nm, ≥1200 nm and ≤1240 nm, ≥1200 nm and ≤1220 nm, ≥1220 nm and ≤1260 nm, ≥1220 nm and ≤1240 nm, or ≥1240 nm and ≤1260 nm.

### MACC Value

The MACC value of an optical fiber may be used to determine the bend sensitivity of the fiber. The MACC value is defined as the ratio of mode field diameter (converted to nm) to the 22 m cable cutoff (nm).

In some embodiments, the optical fibers disclosed herein may have a MACC value, at 1310 nm wavelength, greater than or equal to (i.e., ≥) 7.5 and less than or equal to (i.e., ≤) 8.3—including all sub-ranges or values therebetween. For example, in some embodiments, the optical fibers disclosed herein may have a MACC value, at 1310 nm wavelength, ≥7.5 and ≤8.3, ≥7.5 and ≤8.2, ≥7.5 and ≤8.1, ≥7.5 and ≤8.0, ≥7.5 and ≤7.9, ≥7.5 and ≤7.8, ≥7.5 and ≤7.7, ≥7.5 and ≤7.6, ≥7.6 and ≤8.3, ≥7.6 and ≤8.2, ≥7.6 and ≤8.1, ≥7.6 and ≤8.0, ≥7.6 and ≤7.9, ≥7.6 and ≤7.8, ≥7.6 and ≤7.7, ≥7.7and ≤8.3, ≥7.7 and ≤8.2, ≥7.7 and ≤8.1, ≥7.7 and ≤8.0, ≥7.7 and ≤7.9, ≥7.7 and ≤7.8, ≥7.8and ≤8.3, ≥7.8 and ≤8.2, ≥7.8 and ≤8.1, ≥7.8 and ≤8.0, ≥7.8 and ≤7.9, ≥7.9 and ≤8.3, ≥7.9 and ≤8.2, ≥7.9 and ≤8.1, ≥7.9 and ≤8.0, ≥8.0 and ≤8.3, ≥8.0 and ≤8.2, ≥8.0 and ≤8.1, ≥8.1 and ≤8.3, ≥8.1 and ≤8.2, or ≥8.2 and ≤8.3.

In some embodiments, the optical fibers disclosed herein may have a MACC value, at 1310 nm wavelength, greater than or equal to (i.e., ≥) 7.5, ≥7.6, ≥7.7, ≥7.8, ≥7.9, ≥8.0, ≥8.1, ≥8.2, or greater. In some embodiments, the optical fibers disclosed herein may have a MACC value, at 1310 nm wavelength, less than or equal to (i.e., ≤) 8.3, ≤8.2, ≤8.1, ≤8.0, ≤7.9, ≤7.8, ≤7.7, ≤7.6, or less.

In some embodiments, the optical fibers disclosed herein may have a MACC value, at 1550 nm wavelength, greater than or equal to (i.e., ≥) 8 and less than or equal to (i.e., ≤) 10—including all sub-ranges or values therebetween. For example, in some embodiments, the optical fibers disclosed herein may have a MACC value, at 1550 nm wavelength, ≥8 and ≤10, ≥8 and ≤9.6, ≥8 and ≤9.2, ≥8 and ≤8.8, ≥8 and ≤8.4, ≥8.4 and ≤10, ≥8.4 and ≤9.6, ≥8.4 and ≤9.2, ≥8.4 and ≤8.8, ≥8.8 and ≤10, ≥8.8 and ≤9.6, ≥8.8 and ≤9.2, ≥9.2 and ≤10, ≥9.2 and ≤9.6, or ≥9.6 and ≤10.

In some embodiments, the optical fibers disclosed herein may have a MACC value, at 1550 nm wavelength, greater than or equal to (i.e., ≥) 8, ≥8.1, ≥8.2, ≥8.3, ≥8.4, ≥8.5, ≥8.6, ≥8.7, ≥8.8, ≥8.9, ≥9, ≥9.1, ≥9.2, ≥9.3, ≥9.4, ≥9.5, ≥9.6, ≥9.8, ≥9.9, or greater. In some embodiments, the optical fibers disclosed herein may have a MACC value, at 1550 nm wavelength, less than or equal to (i.e., ≤) 10, ≤9.9, ≤9.8, ≤9.7, ≤9.6, ≤9.5, ≤9.4, ≤9.3, ≤9.2, ≤9.1, ≤9, ≤8.9, ≤8.8, ≤8.7, ≤8.6, ≤8.5, ≤8.4, ≤8.3, ≤8.2, ≤8.1, or less.

### Zero Dispersion Wavelength (λ₀)

The optical fibers disclosed herein may also have a zero dispersion wavelength (20) greater than or equal to (i.e., ≥) 1300 nm and less than or equal to (i.e., ≤) 1324 nm—including all sub-ranges or values therebetween. For example, in some embodiments, the zero dispersion wavelength (2) of the optical fibers disclosed herein may be ≥1300 nm and ≤1324 nm, ≥1300 nm and ≤1320 nm, ≥1300 nm and ≤1315 nm, ≥1300 nm and ≤1310 nm, ≥1300 nm and ≤1305 nm, ≥1305 nm and ≤1324 nm, ≥1305 nm and ≤1320 nm, ≥1305 nm and ≤1315 nm, ≥1305 nm and ≤1310 nm, ≥1310 nm and ≤1324 nm, ≥1310 nm and ≤1320 nm, ≥1310 nm and ≤1315 nm, ≥1315 nm and ≤1324 nm, ≥1315 nm and ≤1320 nm, or ≥1320 nm and ≤1324 nm.

In some embodiments, the zero dispersion wavelength (2) of the optical fibers disclosed herein may be greater than or equal to (i.e., ≥) 1300 nm, ≥1305 nm, ≥1310 nm, ≥1315 nm, ≥1320 nm, or greater. In some embodiments, the zero dispersion wavelength (λ₀) of the optical fibers disclosed herein may be less than or equal to (i.e., ≤) 1324 nm, ≤1320 nm, ≤1315 nm, ≤1310 nm, ≤1305 nm, or less.

### Dispersion

Further, in some embodiments, the optical fibers described herein may have a dispersion, at 1310 nm wavelength, greater than or equal to (i.e., ≥) −1.5 ps/nm/km and less than or equal to (i.e., ≤) 1.5 ps/nm/km—including all sub-ranges or values therebetween. For example, in some embodiments, the optical fibers described herein may have a dispersion, at 1310 nm wavelength, ≥−1.5 ps/nm/km and ≤1.5 ps/nm/km, ≥−1.2 ps/nm/km and ≤1.2 ps/nm/km, ≥−0.9 ps/nm/km and ≤0.9 ps/nm/km, ≥−0.6 ps/nm/km and ≤0.6 ps/nm/km, ≥−0.3 ps/nm/km and ≤0.3 ps/nm/km, ≥−0.1 ps/nm/km and ≤0.1 ps/nm/km, ≥−0.05 ps/nm/km and ≤0.05 ps/nm/km, or about 0 ps/nm/km.

Further, in some embodiments, the optical fibers described herein may have a dispersion slope, at 1310 nm wavelength, less than or equal to (i.e., ≤) 0.093 ps/nm²/km, ≤0.09 ps/nm²/km, ≤0.085 ps/nm²/km, or ≤0.08 ps/nm²/km.

### Effective Area

Further, in some embodiments, the optical fibers disclosed herein may have an effective area, at 1310 nm wavelength, greater than or equal to (i.e., ≥) 62 μm² and (less than or equal to (i.e., ≤) 70 μm²—including all sub-ranges or values therebetween. For example, in some embodiments, the optical fibers disclosed herein may have an effective area, at 1310 nm wavelength, ≥62 μm² and ≤70 μm², ≥62 μm² and ≤68 μm², ≥62 μm² and ≤66 μm², ≥62 μm² and ≤64 μm², ≥64 μm² and ≤70 μm², ≥64 μm² and ≤68 μm², ≥64 μm² and ≤66 μm², ≥66 μm² and ≤70 μm², ≥66 μm² and ≤68 μm², or ≥68 μm² and ≤70 μm². In some embodiments, the optical fibers disclosed herein may have an effective area, at 1310 nm wavelength, greater than or equal to (i.e., ≥) 62 μm², ≥63 μm², ≥64 μm², ≥65 μm², ≥66 μm², ≥67 μm², ≥68 μm², ≥69 μm², or greater. In some embodiments, the optical fibers disclosed herein may have an effective area, at 1310 nm wavelength, less than or equal to (i.e., ≤) 70 μm², ≤69 μm², ≤68 μm², ≤67 μm², ≤66 μm², ≤65 μm², ≤64 μm², ≤63 μm², or less.

Further, in some embodiments, the optical fibers disclosed herein may have an effective area, at 1550 nm wavelength, greater than or equal to (i.e., ≥) 77 μm² and less than or equal to (i.e., ≤) 90 μm²—including all sub-ranges or values therebetween. For example, in some embodiments, the optical fibers disclosed herein may have an effective area, at 1550 nm wavelength, ≥77 μm² and ≤90 μm², ≥77 μm² and ≤87 μm², ≥77 μm² and ≤84 μm², ≥77 μm² and ≤80 μm², ≥80 μm² and ≤90 μm², ≥80 μm² and ≤87 μm², ≥80 μm² and ≤84 μm², ≥84 μm² and ≤90 μm², ≥84 μm² and ≤87 μm², or ≥87 μm² and ≤90 μm². In some embodiments, the optical fibers disclosed herein may have an effective area, at 1550 nm wavelength, greater than or equal to (i.e., ≥) 77 μm², ≥78 μm², ≥79 μm², ≥80 μm², ≥81 μm², ≥82 μm², ≥83 μm², ≥84 μm², ≥85 μm², ≥86 μm², ≥87 μm², ≥88 μm², ≥89 μm², or greater. In some embodiments, the optical fibers disclosed herein may have an effective area, at 1550 nm wavelength, less than or equal to (i.e., ≤) 90 μm², ≤89 μm², ≤88 μm², ≤87 μm², ≤86 μm², ≤85 μm², ≤84 μm², ≤83 μm², ≤82 μm², ≤81 μm², ≤80 μm², ≤79 μm², ≤78 μm², or less.

### Attenuation

In some embodiments, the attenuation of the optical fibers disclosed herein may be, at 1310 nm wavelength, less than or equal to (i.e., ≤) 0.33 dB/km, ≤0.325 dB/km, ≤0.32 dB/km, or ≤0.315 dB/km.

In some embodiments, the attenuation of the optical fibers disclosed herein may be, at 1550 nm wavelength, less than or equal to (i.e., ≤) 0.2 dB/km, ≤0.19 dB/km, ≤0.185 dB/km, or ≤0.18 dB/km.

In some embodiments, the attenuation of the optical fibers disclosed herein may be, at 1625 nm wavelength, less than or equal to (i.e., ≤) 0.25 dB/km, ≤0.24 dB/km, ≤0.22 dB/km, or ≤0.20 dB/km.

The optical fibers described herein may be drawn from optical fiber preforms using fiber draw methods and apparatus, for example as is disclosed in U.S. Pat. Nos. 7,565,820 and 9,309,143, the entire contents of which are incorporated by reference herein. Non-limiting exemplary coating materials and methods are discussed in U.S. Pat. No. 9,057,817, the entire content of which is incorporated by reference herein.

### EXAMPLES

Provided below are exemplary embodiments of the optical fibers disclosed herein. The below examples are intended to be exemplary and are not intended to limit the scope of the disclosure.

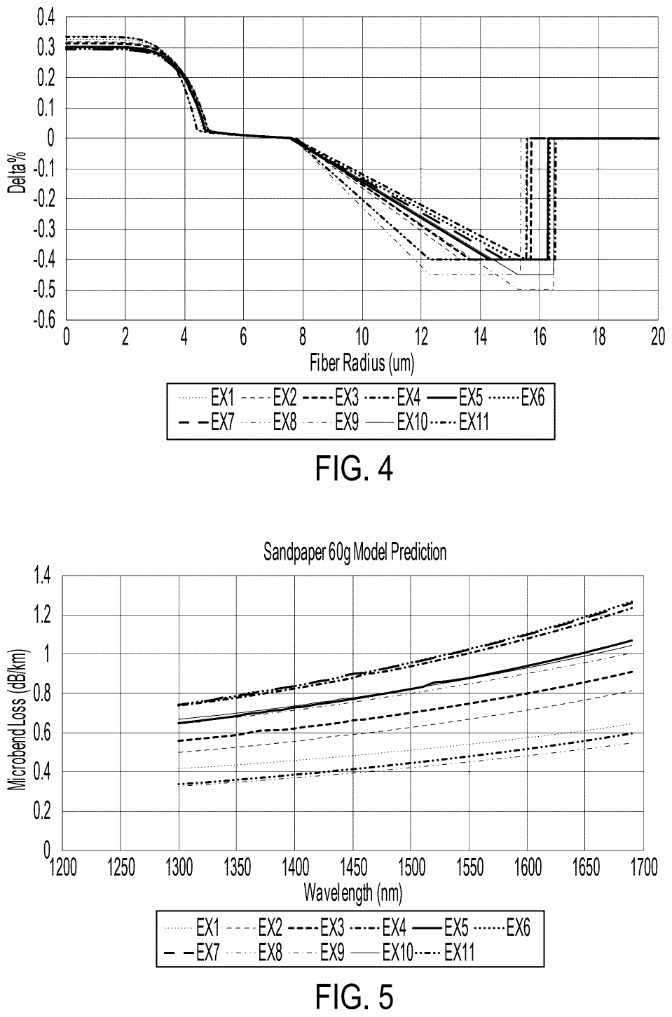

FIG. 4 shows the relative refractive index profiles for exemplary fibers Examples 1-11. Table 1 below provides the parameters and modeled attributes of the exemplary fibers of Examples 1-11. Examples 1-11 provide a broad range of mode field diameters from about 9.0 μm to about 9.6 μm at 1310 nm. Examples 1-11 may have different minimum refractive indices Δ_{3 min} in the respective depressed-index cladding regions, different widths of the respective first, sloped regions of the depressed-index cladding regions, different widths of the respective second regions of the depressed-index cladding regions having the minimum refractive indices Δ_{3 min}, and/or different overall widths of the respective depressed-index cladding regions. The differences in the minimum refractive indices Δ_{3 min}, the widths of the first regions, the widths of the second regions, and/or the overall widths of the depressed-index cladding regions may accommodate different design and/or performance needs, manufacturing requirements, and/or other considerations.

TABLE 1

| | Ex. 1 | Ex. 2 | Ex. 3 | Ex. 4 | Ex. 5 | Ex. 6 | Ex. 7 |
|---|---|---|---|---|---|---|---|
| Δ₁ₘₐₓ (%) | 0.327 | 0.319 | 0.314 | 0.301 | 0.302 | 0.296 | 0.294 |
| Core radius r₁ (μm) | 4.925 | 4.950 | 5.000 | 5.075 | 4.975 | 5.025 | 5.000 |
| Core alpha | 6.000 | 6.000 | 6.000 | 6.000 | 6.000 | 6.000 | 6.000 |
| Depressed-index | 7.675 | 7.675 | 7.750 | 7.675 | 7.550 | 7.575 | 7.550 |
| cladding region inner | | | | | | | |
| radius r₂ (μm) | | | | | | | |
| Depressed-index | 15.550 | 15.575 | 15.700 | 16.525 | 16.275 | 16.325 | 16.275 |
| cladding region outer | | | | | | | |
| radius r₃ (μm) | | | | | | | |
| Δ₃ₘᵢₙ (%) | −0.400 | −0.400 | −0.400 | −0.400 | −0.400 | −0.400 | −0.400 |
| Glass fiber radius r₄ | 62.500 | 62.500 | 62.500 | 62.500 | 62.500 | 62.500 | 62.500 |
| (μm) | | | | | | | |
| Trench volume \|V₃\| | 56.332 | 51.919 | 51.771 | 53.456 | 56.712 | 53.153 | 54.298 |
| MFD at 1310 nm (μm) | 9.200 | 9.323 | 9.402 | 9.602 | 9.507 | 9.603 | 9.601 |
| Zero dispersion λ₀ (nm) | 1308.3 | 1308.2 | 1307.8 | 1306.9 | 1307.9 | 1308.0 | 1308.3 |
| Cable cutoff (nm) | 1220.1 | 1217.5 | 1218.7 | 1218.0 | 1192.5 | 1190.7 | 1170.1 |
| MFD at 1550 nm (μm) | 10.310 | 10.461 | 10.552 | 10.787 | 10.682 | 10.801 | 10.802 |
| Microbend loss (dB/km) | 0.541 | 0.668 | 0.748 | 1.005 | 0.878 | 1.026 | 1.023 |
| at 1550 nm | | | | | | | |
| Microbend loss (dB/km) | 0.592 | 0.740 | 0.828 | 1.119 | 0.973 | 1.145 | 1.140 |
| at 1625 nm | | | | | | | |
| MACC at 1310 nm | 7.540 | 7.657 | 7.715 | 7.883 | 7.972 | 8.065 | 8.205 |
| MACC at 1550 nm | 8.450 | 8.592 | 8.658 | 8.856 | 8.958 | 9.071 | 9.231 |
| 1 × 15 mm Macrobend | 0.074 | 0.106 | 0.109 | 0.118 | 0.101 | 0.140 | 0.143 |
| Loss (dB) 1550 nm | | | | | | | |
| 1 × 20 mm Macrobend | 0.068 | 0.105 | 0.108 | 0.107 | 0.081 | 0.103 | 0.090 |
| Loss (dB) 1550 nm | | | | | | | |
| 1 × 30 mm Macrobend | 0.003 | 0.005 | 0.005 | 0.007 | 0.007 | 0.013 | 0.018 |
| Loss (dB) 1550 nm | | | | | | | |
| 1 × 15 mm Macrobend | 0.218 | 0.297 | 0.300 | 0.310 | 0.233 | 0.306 | 0.290 |
| Loss (dB) 1625 nm | | | | | | | |
| 1 × 20 mm Macrobend | 0.142 | 0.236 | 0.252 | 0.270 | 0.217 | 0.277 | 0.253 |
| Loss (dB) 1625 nm | | | | | | | |
| 1 × 30 mm Macrobend | 0.010 | 0.015 | 0.016 | 0.020 | 0.024 | 0.038 | 0.052 |
| Loss (dB) 1625 nm | | | | | | | |

| | Ex. 8 | Ex. 9 | Ex. 10 | Ex. 11 |
|---|---|---|---|---|
| Δ₁ₘₐₓ (%) | 0.336 | 0.303 | 0.305 | 0.336 |
| Core radius r₁ (μm) | 4.775 | 5.025 | 5.100 | 4.800 |
| Core alpha | 6.000 | 6.000 | 6.000 | 6.000 |
| Depressed-index | 7.675 | 7.650 | 7.500 | 7.675 |
| cladding region inner | | | | |
| radius r₂ (μm) | | | | |
| Depressed-index | 15.350 | 16.475 | 16.500 | 15.550 |
| cladding region outer | | | | |
| radius r₃ (μm) | | | | |
| Δ₃ₘᵢₙ (%) | −0.450 | −0.500 | −0.450 | −0.400 |
| Glass fiber radius r₄ | 62.500 | 62.500 | 62.500 | 62.500 |
| (μm) | | | | |
| Trench volume \|V₃\| | 60.590 | 67.556 | 60.973 | 56.332 |
| MFD at 1310 nm (μm) | 9.014 | 9.508 | 9.538 | 9.024 |
| Zero dispersion λ₀ (nm) | 1313.1 | 1307.1 | 1305.9 | 1314.2 |
| Cable cutoff (nm) | 1188.3 | 1198.9 | 1230.0 | 1189.8 |
| MFD at 1550 nm (μm) | 10.139 | 10.670 | 10.694 | 10.167 |
| Microbend loss (dB/km) | 0.451 | 0.848 | 0.875 | 0.479 |
| at 1550 nm | | | | |
| Microbend loss (dB/km) | 0.499 | 0.928 | 0.960 | 0.537 |
| at 1625 nm | | | | |
| MACC at 1310 nm | 7.585 | 7.930 | 7.754 | 7.585 |
| MACC at 1550 nm | 8.532 | 8.899 | 8.694 | 8.545 |
| 1 × 15 mm Macrobend | 0.058 | 0.054 | 0.073 | 0.072 |
| Loss (dB) 1550 nm | | | | |
| 1 × 20 mm Macrobend | 0.059 | 0.048 | 0.069 | 0.072 |
| Loss (dB) 1550 nm | | | | |
| 1 × 30 mm Macrobend | 0.003 | 0.004 | 0.004 | 0.003 |
| Loss (dB) 1550 nm | | | | |
| 1 × 15 mm Macrobend | 0.161 | 0.137 | 0.203 | 0.203 |
| Loss (dB) 1625 nm | | | | |
| 1 × 20 mm Macrobend | 0.141 | 0.127 | 0.170 | 0.169 |
| Loss (dB) 1625 nm | | | | |
| 1 × 30 mm Macrobend | 0.009 | 0.012 | 0.012 | 0.011 |
| Loss (dB) 1625 nm | | | | |

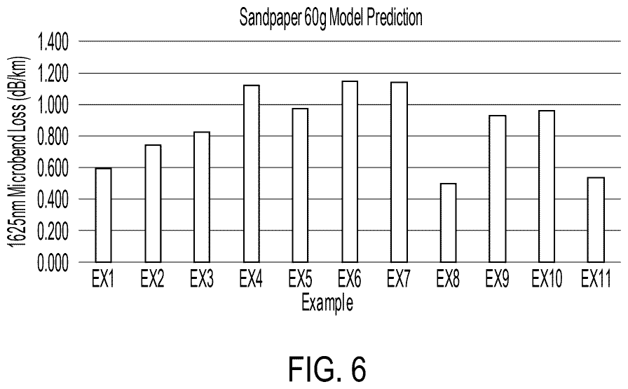

FIG. 5 plots the model prediction of microbend loss as a function of wavelength for the exemplary fibers of Examples 1-11 based on a coated fiber diameter of 190 μm and a nominal mode field diameter of 9.2 μm at 1310 nm. FIG. 6 plots the model prediction of microbend loss at 1625 nm.

As shown, the optical fibers disclosed herein may achieve low microbend loss at a relatively large mode field diameter, while also maintaining low macrobend loss, low cable cutoff, and/or a zero dispersion wavelength between 1300 nm and 1324 nm. The optical fibers disclosed herein meet or exceed the G.657.A2 standard.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. An optical fiber, comprising:
a core region; and
a cladding region surrounding the core region, the cladding region comprising an inner cladding region surrounding the core region, a depressed-index cladding region surrounding the inner cladding region, and an outer cladding region surrounding the depressed-index cladding region, wherein:
the inner cladding region has a thickness greater than or equal to 1 μm;
the depressed-index cladding region comprises a first region and a second region, wherein a relative refractive index of the depressed-index cladding region decreases monotonically with increasing radius in the first region, wherein the relative refractive index of the depressed-index cladding region is substantially constant in the second region;
a minimum relative refractive index Δ_{3 min} of the depressed-index cladding region is less than or equal to −0.4%;
a trench volume of the depressed-index cladding region is greater than or equal to 30%-micron² and less than or equal to 70%-micron²;
wherein the optical fiber exhibits:
a MACC value, at 1310 nm wavelength, greater than or equal to 7.5 and less than or equal 8.3;
a mode field diameter at 1310 μm wavelength greater than or equal to 9.0 μm;
a cable cutoff less than or equal to 1260 nm;
a zero dispersion wavelength greater than or equal to 1300 nm and less than or equal to 1324 nm; and
at least one of:
a macrobend loss, as determined by 1×15 mm diameter mandrel wrap test at 1310 nm wavelength, less than or equal to 0.02 dB/turn;
a macrobend loss, as determined by 1×20 mm diameter mandrel wrap test at 1310 nm wavelength, less than or equal to 0.002 dB/turn; or
a macrobend loss, as determined by 1×30 mm diameter mandrel wrap test at 1310 nm wavelength, less than or equal to 0.00005 dB/turn.

2. The optical fiber according to claim 1, wherein when incorporated in a cable having a fiber density greater than or equal to 6 fibers/mm², the optical fiber exhibits an attenuation change of less than 0.15 dB/km at 1550 nm when the cable is thermal cycled between −40° C. and 70° C.

3. The optical fiber according to claim 1, wherein when incorporated in a cable having a fiber density greater than or equal to 8 fibers/mm², the optical fiber exhibits an attenuation change of less than 0.15 dB/km at 1550 nm when the cable is thermal cycled between −40° C. and 70° C.

4. The optical fiber according to claim 1, wherein the optical fiber further exhibits at least one of:
a microbend loss, at 1625 nm wavelength, less than or equal to 1.5 dB/km;
a microbend loss, at 1550 nm wavelength, less than or equal to 1.2 dB/km; or
a microbend loss, at 1310 nm wavelength, less than or equal to 1 dB/km.

5. The optical fiber according to claim 1, wherein an alpha of the core region is greater than or equal to 2 and less than or equal to 20.

6. The optical fiber according to claim 1, wherein the thickness of the inner cladding region is greater than or equal to 1 μm and less than or equal to 10 μm.

7. The optical fiber according to claim 1, wherein an outer radius r₂ of the inner cladding region is greater than or equal to 6 μm and less than or equal to 14 μm.

8. The optical fiber according to claim 1, wherein the relative refractive index of the depressed-index cladding region decreases linearly with increasing radius in the first region.

9. The optical fiber according to claim 1, wherein an outer radius r_{3 min} of the first region of the depressed-index cladding region is greater than or equal to 7 μm and less than or equal to 19 μm.

10. The optical fiber according to claim 1, wherein a thickness of the first region of the depressed-index cladding region is greater than or equal to 2 μm and less than or equal to 8 μm.

11. The optical fiber according to claim 1, wherein a thickness of the second region of the depressed-index cladding region is greater than or equal to 1 μm and less than or equal to 7 μm.

12. The optical fiber according to claim 1, wherein the second region of the depressed-index cladding region directly contacts the first region of the depressed-index cladding region.

13. The optical fiber according to claim 1, wherein the minimum relative refractive index Δ_{3 min} of the depressed-index cladding region is less than or equal to −0.4% and greater than or equal to −0.6%.

14. The optical fiber according to claim 1, wherein an outer radius r₃ of the depressed-index cladding region is greater than or equal to 8 μm and less than or equal to 20 μm.

15. The optical fiber according to claim 1, wherein a thickness of the depressed-index cladding region is greater than or equal to 3 μm and less than or equal to 15 μm.

16. The optical fiber according to claim 1, wherein an outer radius r₁ of the core region is greater than or equal to 3 μm and less than or equal to 7 μm.

17. The optical fiber according to claim 1, wherein a maximum relative refractive index Δ_{1 max} of the core region is greater than or equal to 0.15% and less than or equal to 0.5%.

18. The optical fiber according to claim 1, wherein an outer diameter of the outer cladding region is greater than or equal to 80 μm and less than or equal to 130 μm, greater than or equal to 80 μm and less than or equal to 120 μm, or about 125 μm.

19. The optical fiber according to claim 1, comprises a glass fiber, wherein the glass fiber comprises the core region and the cladding region, and wherein the outer cladding region forms an outermost layer of the glass fiber.

20. The optical fiber according to claim 1, further comprising a primary coating surrounding the outer cladding region and a secondary coating surrounding the primary coating.
